(19) United States
(12) Patent Application Publication
(10) Pub. No.: US 2025/0132868 A1
(43) Pub. Date: Apr. 24, 2025

(54) COMMUNICATION METHOD, NETWORK NODE, STORAGE MEDIUM, AND PROGRAM PRODUCT

(71) Applicant: Samsung Electronics Co., Ltd., Suwon-si (KR)

(72) Inventors: Xin ZHOU, Beijing (CN); Honghong LI, Beijing (CN); Junwei REN, Beijing (CN); Ying ZHU, Beijing (CN); Zhigang WANG, Beijing (CN); Nan CAO, Beijing (CN)

(21) Appl. No.: 18/899,775

(22) Filed: Sep. 27, 2024

Related U.S. Application Data
(63) Continuation of application No. PCT/KR2024/012735, filed on Aug. 26, 2024.

(30) Foreign Application Priority Data
Oct. 20, 2023 (CN) 202311371317.1

(51) Int. Cl. H04L 1/1867; H04L 1/1812; H04L 41/16; H04W 24/10

(52) U.S. Cl. CPC H04L 1/1887; H04L 1/1812; H04L 41/16; H04W 24/10

(57) ABSTRACT

Embodiments of the present disclosure provide a communication method, a network node, a storage medium and a program product, and relate to fields such as communication and artificial intelligence. In an example method, a first network node determines a first retransmission UE, determines an MU pairing recommendation result using a first AI network based on the first retransmission UE, and transmits the MU pairing recommendation result to a second network node, so that the computation of MU scheduling of the second network node can be assisted, and the computation complexity of MU scheduling of the second network node can be reduced. Optionally, the method performed by a network node can be performed by an artificial intelligence mode

### CROSS-REFERENCE TO RELATED APPLICATIONS

This application is a continuation of International Application No. PCT/KR2024/012735 designating the United States, filed on Aug. 26, 2024, in the Korean Intellectual Property Receiving Office and claiming priority to Chinese Patent Application No. 202311371317.1, filed on Oct. 20, 2023, in the Chinese Patent Office, the disclosures of each of which are incorporated by reference herein in their entireties.

### BACKGROUND

### Field

The disclosure relates to communication, and for example, to a communication method, a network node, a storage medium and a program product.

### Description of Related Art

The massive multi-input multi-output (mMIMO, also referred to as massive MIMO) technology is a key technology in the 5th generation (5G)/beyond 5th generation (B5G) communication. In order to support more antennas, more UEs per cell and more cells per base station, the computation complexity of multi-user (MU) scheduling is greatly increased. Without changing hardware conditions, how to reduce the computation complexity of MU scheduling becomes a technical problem to be urgently addressed.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address reducing the computation complexity of MU scheduling.

In accordance with an example embodiment, a method performed by a first network node in a communication system is provided, including: determining a first retransmission user equipment (UE), determining a multi-user (MU) pairing recommendation result using a first artificial intelligence (AI) network based on the first retransmission UE, and transmitting the recommended result of MU pairing to a second network node.

The determining a first retransmission UE may include determining the retransmission probability of at least one UE, and determining a first retransmission UE based on the retransmission probability of the at least one UE.

The determining the retransmission probability of at least one UE may include determining the retransmission probability of the at least one UE according to a historical MU pairing recommendation result and a target block error ratio.

The determining the retransmission probability of the at least one UE according to a historical MU pairing recommendation result and a target block error ratio may include determining the number of times of using the at least one UE as initial transmission in the historical MU pairing recommendation result, determining the retransmission probability of initial transmission based on the target block error ratio, and determining the retransmission probability of the at least one UE based on the number of times of initial transmission and the retransmission probability of initial transmission.

The determining a first retransmission UE based on the retransmission probability of the at least one UE may include determining a retransmission validity threshold corresponding to the at least one UE, and determining a first retransmission UE based on the retransmission probability of the at least one UE and the retransmission validity threshold corresponding to the at least one UE.

The determining a retransmission validity threshold corresponding to the at least one UE may include determining the retransmission validity threshold corresponding to the at least one UE according to historical scheduling information.

The determining the retransmission validity threshold corresponding to the at least one UE according to historical scheduling information may include determining a historical MU pairing recommendation result validity metric according to the historical scheduling information, the MU pairing recommendation result validity metric being used to measure the validity of retransmission UEs in the historical MU pairing recommendation result, and determining, according to the historical MU pairing recommendation result validity metric and using a second AI network, a retransmission validity threshold corresponding to at least one UE in each first time unit set in a current period.

The each first time unit set may include at least one first time unit in which HARQ feedback is performed on a same continuous uplink second time unit.

The historical scheduling information may include at least one of a MU-scheduled first time unit, a first time unit in which the second network node determines the MU pairing recommendation result, a first time unit in which the second network node uses the MU pairing recommendation result provided by the first network node, the actual usage condition of the MU pairing recommendation result provided by the first network node by the second network node in each first time unit set of the historical period, and the number of first time units MU-scheduled by the second network node in each first time unit set of the historical period.

The determining a first retransmission UE based on the retransmission probability of the at least one UE and the retransmission validity threshold corresponding to the at least one UE may include determining a first retransmission UE based on the comparison result of the retransmission probability of the at least one UE and the retransmission validity threshold corresponding to the at least one UE.

The determining a first retransmission UE based on the comparison result of the retransmission probability of the at least one UE and the retransmission validity threshold corresponding to the at least one UE may include sorting the at least one UE in the order from smallest to largest retransmission probabilities, performing the following operation successively on the sorted at least one UE until a target UE is determined: determining the cumulative retransmission probability of a UE and UEs before this UE, determining the corresponding retransmission validity probability based on the cumulative retransmission probability, and determining this UE as a target UE if the retransmission validity probability is less than the retransmission validity threshold, and determining the target UE and UEs after the target UE as first retransmission UEs.

The determining a MU pairing recommendation result using a first AI network based on the first retransmission UE may include determining at least one candidate UE according to the amount of data to be transmitted of UEs and measurement configuration information, and determining a MU pairing recommendation result using the first AI network based on the first retransmission UE and the at least one candidate UE.

The determining at least one candidate UE according to the amount of data to be transmitted of UEs and measurement configuration information may include determining at least one candidate UE according to the amount of data to be transmitted of UEs, the measurement configuration information and a UE scheduling parameter, wherein the UE scheduling parameter is determined according to the number of first time units in which UEs satisfy a preset condition in a preset period of time including a plurality of first time units.

The determining at least one candidate UE according to the amount of data to be transmitted of UEs and measurement configuration information may include determining initial candidate UEs, and deleting, from the initial candidate UEs, candidate UEs whose the amount of data to be transmitted is less than a first threshold, and deleting, from the initial candidate UEs, candidate UEs in measurement gaps according to the measurement configuration information, to obtain at least one candidate UE.

The determining at least one candidate UE according to the amount of data to be transmitted of UEs, the measurement configuration information and a UE scheduling parameter may include determining initial candidate UEs, and deleting, from the initial candidate UEs, candidate UEs whose the amount of data to be transmitted is less than a first threshold, deleting, from the initial candidate UEs, candidate UEs in measurement gaps according to the measurement configuration information, and sorting the initial candidate UEs according to the UE scheduling parameter and/or deleting, from the initial candidate UEs, candidate UEs whose the UE scheduling parameter is greater than a fairness threshold, to obtain at least one candidate UE.

The determining a MU pairing recommendation result using the first AI network based on the first retransmission UE and the at least one candidate UE may include determining a MU pairing recommendation result using the first AI network based on the first retransmission UE, the at least one candidate UE and at least one of the following: a predicted signal to interference plus noise ratio (SINR), a predicted sounding reference signal matrix H_SRS, uplink/downlink slot configuration information, and HARQ related configuration information.

The method may further include training the first AI network to maximize/increase the multi-user-modulation order product code rate (MU-MPR) of the at least one UE. the MU-MPR of each UE may be determined according to at least one of the following: the predicted SINR of the UE, and a multi-user beam forming weight determined based on the predicted H_SRS.

The determining a first retransmission UE may include acquiring the computation capability of the second network node, and determining a first retransmission UE when the computation capability is less than a predetermined condition.

The first network node may include a radio access network intelligent controller (RIC), and the second network node may include a distributed unit (DU).

In accordance with an example embodiment, a method performed by a second network node in a communication system is provided, may include receiving a MU pairing recommendation result transmitted by a first network node, determining whether a current scheduling time unit uses the MU pairing recommendation result, and based on the current scheduling time unit using the MU pairing recommendation result, performing MU scheduling based on the MU pairing recommendation result.

The determining whether the current scheduling time unit uses the MU pairing recommendation result may include determining a second retransmission UE of the current scheduling time unit according to HARQ feedback, and based on there being no second retransmission UE in the current scheduling time unit or the second retransmission UE is included in the MU pairing recommendation result corresponding to the current scheduling time unit, determining that the current scheduling time unit uses the MU pairing recommendation result.

The first network node may include a radio access network intelligent controller (RIC), and the second network node is a distributed unit (DU).

In accordance with an example embodiment, a first network node is provided, including a transceiver, configured to transmit and/or receive signals, and at least one processor, comprising processing circuitry, coupled to the transceiver and configured to execute the method executed by a first network node provided above.

In accordance with yet an example embodiment, a second network node is provided, including a transceiver configured to transmit and/or receive signals, and at least one processor, comprising processing circuitry, coupled to the transceiver and configured to execute the method executed by a second network node provided above.

In accordance with an example embodiment, a non-transitory computer-readable storage medium is provided, the computer-readable storage medium having computer programs stored thereon that, when executed by at least one processor, comprising processing circuitry, individually and/or collectively, implement the method executed by a first network node provided above.

In accordance with an example embodiment, a non-transitory computer-readable storage medium is provided, the computer-readable storage medium having computer programs stored thereon that, when executed by at least one processor, comprising processing circuitry, individually and/or collectively, implement the method executed by a second network node provided above.

In accordance with an example embodiment, a computer program product is provided, including computer programs that, when executed by at least one processor, comprising processing circuitry, individually and/or collectively, implement the method executed by a first network node provided above.

In accordance with an example embodiment, a computer program product is provided, including computer programs that, when executed by at least one processor, comprising processing circuitry, individually and/or collectively, implement the method executed by a second network node provided above.

In the communication method, the network node, the storage medium and the program product provided in various example embodiments, a first network node may determine: a first retransmission UE, a MU pairing recommendation result using a first AI network based on the first retransmission UE, and transmit the MU pairing recommendation result to a second network node, so that the computation of MU scheduling of the second network node can be assisted, and the computation complexity of MU scheduling of the second network node can be reduced.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method executed by a first network node in a communication system according to various embodiments;

FIG. 2 is a diagram illustrating example bundle division in a period according to various embodiments;

FIG. 3 is a diagram illustrating determining an MU-UE list using an AI network according to various embodiments;

FIG. 4 is a signal flow diagram illustrating an example of selecting a scheme based on DU computation capability according to various embodiments;

FIG. 5 is a flowchart illustrating an example method executed by a second network node in a communication system according to various embodiments;

FIG. 6 is a diagram illustrating an example scheduling operation of the DU according to various embodiments;

FIG. 7 is a flowchart illustrating an example process of the DU according to various embodiments;

FIG. 8 is a diagram illustrating an example of jointly completing the MU scheduling process by an RIC and a DU according to various embodiments;

FIG. 9 is a diagram illustrating example periodic information collection by an RIC according to various embodiments;

FIG. 10 is a diagram illustrating example determining an MU-UE list of each TTI in a period according to various embodiments;

FIG. 11 is a diagram illustrating an example operation of the DU based on the MU-UE list according to various embodiments;

FIG. 12 is a illustrating an example processing process of an RTM-Net according to various embodiments;

FIG. 13 is a diagram illustrating an example of deploying a MU scheduling scheme in an RIC and a gNB according to various embodiments;

FIG. 14 is a diagram illustrating the effect of reducing the complexity of the DU according to various embodiments; and

FIG. 15 is a diagram illustrating an example configuration of an electronic device according to various embodiments.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

The following description with reference to the accompanying drawings is provided to facilitate the comprehensive understanding of various example embodiments of the present disclosure. The description includes various specific details to facilitate understanding, but should be regarded as being only illustrative. Therefore, it should be recognized by those skilled in the art that various alterations and modifications can be made to various embodiments described herein without departing from the scope and spirit of the present disclosure. In addition, for the sake of clarity and conciseness, the description of well-known functions and structures may be omitted.

The terms and words used in the following description and claims are not limited to their dictionary meanings, and are simply used to clearly and consistently understand the present disclosure. Therefore, it should be apparent to those skilled in the art that, the following description of various example embodiments of the present disclosure are merely for the illustrative purposes and are not intended to limit the scope of the disclosure, including the appended claims and their equivalents.

It should be understood that the singular forms “a”, “an”, and “the” may also include plural forms, unless the context clearly indicates otherwise. Thus, for example, reference to “component surface” includes reference to one or more of such surfaces. When an element is said to be “connected” or “coupled” to another element, this element can be directly connected or coupled to the another element, or it can refer, for example, to this element and the another element being connected through an intermediate element. In addition, “connection” or “coupling” as used herein may include wireless connection or wireless coupling.

The term “include” or “may include” refers to the existence of the disclosed corresponding function, operation or component that can be used in various embodiments of the present disclosure and does not limit the existence of one or more additional functions, operations or components. In addition, the term “include” or “have” may be construed as denoting a certain characteristic, number, step, operation, element, component or a combination thereof, but should not be construed as excluding the possibility of existence of one or more other characteristics, numbers, steps, operations, elements, components or combinations thereof.

The term “or” used in various embodiments of the present disclosure includes any of the listed terms or all combinations thereof. For example, the expression “A or B” may include A, or may include B, or may include both A and B. When describing multiple (two or more) items, if the relationship among multiple items is not explicitly limited, the multiple items may refer to one, many or all of the multiple items. For example, the description of “parameter A includes A1, A2 and A3” can be realized as that the parameter A includes A1 or A2 or A3, and it can also be realized as that the parameter A includes at least two of the three parameters A1, A2 and A3.

Unless defined differently, all terms (including technical terms or scientific terms) used herein have the same meaning as that understood by those skilled in the art to which the present disclosure belongs. Such terms as those defined in a generally used dictionary are to be interpreted to have the meanings equal to the contextual meanings in the relevant art, and are not to be interpreted to have ideal or excessively formal meanings unless clearly defined in the present disclosure.

At least some of the functions in the apparatus or electronic device provided in the various example embodiments of the present disclosure may be implemented by an AI model. For example, at least one of a plurality of modules of the apparatus or electronic device may be implemented by an AI model. The functions associated with the AI can be performed through a non-volatile memory, a volatile memory, and a processor.

The processor may include one or more processors. The one or more processors may be general-purpose processors such as a central processing unit (CPU) and an application processor (AP), or a pure graphics processing unit, such as a graphics processing unit (GPU), a visual processing unit (VPU), and/or an AI specialized processor, such as a neural processing unit (NPU). The processor according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or more processors may control the processing of input data according to predefined operating rules or artificial intelligence (AI) models stored in the non-volatile memory and the volatile memory. The predefined operating rules or AI models are provided by training or learning.

Providing by learning may refer, for example, to obtaining the predefined operating rules or AI models having a desired characteristic by applying a learning algorithm to a plurality of learning data. The learning may be performed in the apparatus or electronic device itself in which the AI according to various embodiments is performed, and/or may be implemented by a separate server/system.

The AI model may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm may refer, for example, a method of training a predetermined target apparatus (e. g., a robot) using a plurality of learning data to enable, allow, or control the target apparatus to make a determination or prediction. Examples of the learning algorithm include, but not limited to, supervised learning, unsupervised learning, semi-supervised learning, or reinforcement learning.

In accordance with the present disclosure, at least one step (e.g., a step of determining an MU pairing recommendation result, a step of determining a retransmission validity threshold, etc.) in the method executed by an electronic device may be implemented by an AI model. The processor of the electronic device may preprocess data to convert the data into a form suitable for use as an input to the AI model. The AI model may be obtained by training. Here, “obtained by training” may refer, for example, to predefined operating rules or AI models configured to perform desired features (or purposes) being obtained by training a basic AI model with multiple pieces of training data by training algorithms.

In order to make the various aspects, technical concepts and advantages of the present disclosure clear, the technical aspects of the various example embodiments of the present disclosure and the technical effects achieved by the technical aspects of the present disclosure will be described with reference to various embodiments. It should be understood that the following implementations can be referred to, learned from or combined with each other, and the same terms, similar features and similar implementation steps in different implementations may not be repeated.

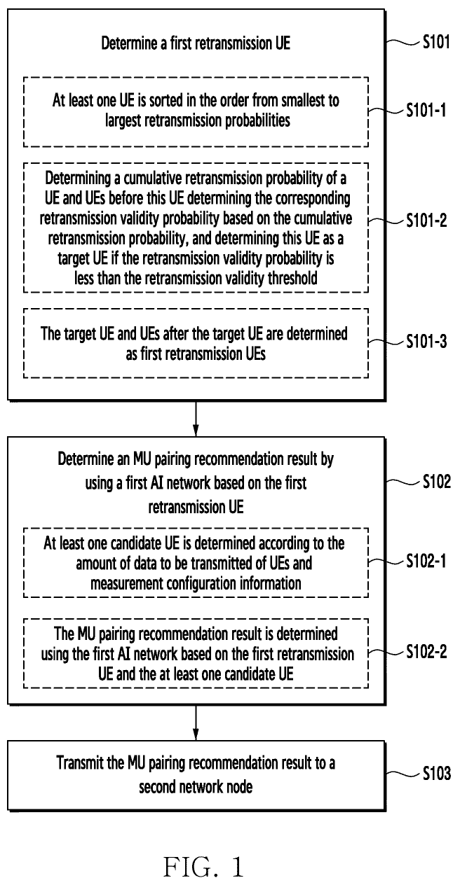

An example embodiment of the present disclosure provides a method executed by a first network node in a communication system. As illustrated in FIG. 1, the method may include the following steps:

In step S101, a first retransmission UE is determined.

The retransmission UE (re-Tx UE) refers to a UE that needs to retransmit data if data transmission fails, the first retransmission UE refers to the retransmission UE predicted by the first network node, which can also be referred to as virtual Re-Tx UE.

In an embodiment, the determined first retransmission UE may be processed in the form of a list. That is, in this step, a first retransmission UE list (Re-Tx UE list) may be directly determined.

In step S102, an MU pairing recommendation result is determined using a first AI network based on the first retransmission UE.

That is, in an embodiment, the determined MU pairing recommendation result includes the first retransmission UE predicted by the first network node, ensuring that the MU pairing recommendation result provided by the first network node is valid for the final MU transmission.

In an embodiment, various implementations of this step may use the first AI network. In practical applications, those skilled in the art can set the specific AI network used in this step according to the actual situation, and it is not limited in the example.

In an embodiment, the MU pairing recommendation result may be specifically an MU-UE list (also referred to as an MU list), but it is not limited thereto.

In step S103, the MU pairing recommendation result is transmitted to a second network node.

In an embodiment, the first network node transmits the determined MU pairing recommendation result to the second network node, so that the second network node performs MU scheduling using the MU pairing recommendation result, for example, performing MU layer decision and resource allocation, thereby reducing the complexity of MU scheduling of the second network node.

In an embodiment, the first network node may be a radio access network intelligent controller (RIC), and the second network node may be a distributed unit (DU). The following problems in the current communication system can be addressed.

In the current communication system, the 5G mMIMO BS (base station) includes three parts, e.g., a central unit (CU), a DU and a Massive MIMO (mMIMO) unit. An MMIMO scheduler is a medium access control (MAC) scheduler in the DU. The key function of the mMIMO scheduler is to realize the spatial reuse of the TDD system through UE pairing. In order to support more antennas, more UEs per cell and more cells per DU base station, the computation complexity of MU scheduling of the DU mMIMO scheduler is greatly increased.

Moreover, due to the delay (the typical delay is 10 ms to 100 ms) between the DU and the RIC, the RIC cannot obtain hybrid automatic repeat request (HARQ) acknowledge character (ACK)/negative acknowledgement character (NACK) feedback information in time, so that the RIC cannot know UEs that need to perform retransmission, and the MU pairing recommendation result generated by the RIC may not include retransmission UEs. Therefore, the DU will not perform final scheduling using the MU pairing recommendation result generated by the RIC, because the MU pairing recommendation result generated in the RIC is invalid for the final MU transmission. That is, due to the delay of HARQ retransmission, it is difficult to reduce the computation complexity of the DU using the RIC.

In view of at least one of the above technical problems or where improvement is needed, the present disclosure provides an RIC-based intelligent mMIMO scheme. By determining the MU pairing recommendation result including retransmission UEs, the RIC effectively reduces the computation complexity of the DU mMIMO scheduler (also referred to as the DU scheduler) to satisfy hardware limitations. Moreover, the retransmission delay problem in the existing technical solutions is addressed, and the system performance is maintained.

For example, in the method executed by a first network node (RIC) in a communication system provided in an embodiment, a first retransmission UE is determined, and an MU pairing recommendation result is determined using a first AI network based on the first retransmission UE, thereby ensuring that the MU pairing recommendation result generated in the first network node (RIC) is valid for the final MU transmission. The MU pairing recommendation result is transmitted to a second network node (DU), so that the scheduling computation of the second network node (DU) can be assisted, and the computation complexity of the DU mMIMO (also referred to as the DU scheduler) can be reduced.

In addition, in the method executed by a first network node (RIC) in a communication system provided in an embodiment, the retransmission delay problem is taken into consideration, and the first network node (RIC) predicts a first retransmission UE and determines an MU pairing recommendation result using a first AI network based on the first retransmission UE, thereby ensuring that the MU pairing recommendation result generated in the first network node (RIC) is valid for the final MU transmission, and addressing the retransmission delay problem that is not addressed in the prior art.

In an embodiment, an optional implementation is provided for the step S101. For example, this optional implementation may include: determining a retransmission probability of at least one UE; and, determining a first retransmission UE based on the retransmission probability of the at least one UE.

In an embodiment, the retransmission probability of a UE refers to the probability that each UE may perform retransmission as estimated by the first network node.

Optionally, for each UE in one or more first time unit in a period, the retransmission probability of the UE may be determined, and a first retransmission UE may be determined based on the determined retransmission probability of the UE. Here, the first time unit may refer to a transmission time interval (TTI), but it is not limited thereto.

In an optional implementation, the retransmission probability of at least one UE may be determined according to a historical MU pairing recommendation result. As an example, the retransmission probability of at least one UE is calculated according to one generated MU pairing recommendation result on the first network node.

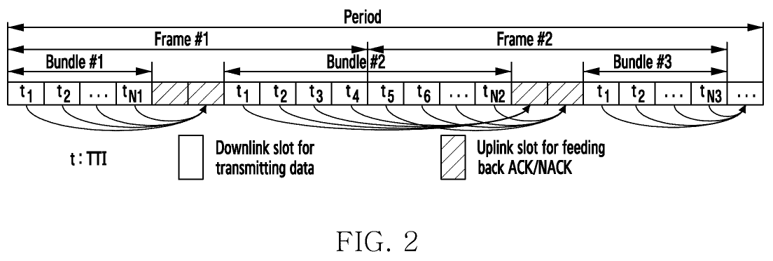

In an embodiment, the historical MU pairing recommendation result may correspond to a first time unit set (bundle). One bundle is a set of first time units (e.g., a set of TTIs), and the HARQ ACK/NACK feedback associated with this set of first time units is all located on the same continuous uplink (UL) second time unit (for example, the second time unit here may refer to a slot). According to the transmission timing relationship between data and HARQ ACK/NACK feedback, the first time units in a period are clustered to obtain each bundle. FIG. 2 shows the division of bundles in a period. In an embodiment, a plurality of bundles are included in a period, and each bundle includes a plurality of downlink first time units (TTIs), where the number of first time units corresponding to different bundles may be the same or different. That is, N1 to N3 in FIG. 2 may be the same or different. In practical applications, based on different transmission timing designs, the bundles may also be divided in other ways, but it is not limited in the embodiments of the present application. In addition, the bundle can also be interpreted as a third time unit.

In an embodiment, the retransmission probability of each UE in the current bundle may be calculated according to the MU pairing recommendation result of the previous bundle. As an example, if it is assumed that the current bundle is bundle b, the retransmission probability of each UE in each first time unit of the bundle b may be calculated according to the MU pairing recommendation result of the bundle b−1. However, it is not limited thereto. In practical applications, the retransmission probability of each UE in the current bundle may be calculated according to the MU pairing recommendation results of one or more historical bundles or one or more historical periods.

In an embodiment, for example, the retransmission probability of at least one UE may be determined according to a historical MU pairing recommendation result and a target block error ratio (BLER).

As an example, the retransmission probability of the corresponding UE is calculated according to the MU pairing recommendation result of the previous bundle and based on the target BLER.

In an optional implementation, the process of “determining the retransmission probability of the at least one UE according to a historical MU pairing recommendation result and a target BLER” may include the following steps.

In optional step 1-1, the number of times of using the at least one UE as initial transmission in the historical MU pairing recommendation result is determined.

As an example, the UE information in the MU pairing recommendation result of the previous bundle (e.g., the above bundle b−1) is read, and the number of times of using each UE as initial transmission in the MU pairing recommendation result of the previous bundle is determined.

In optional step 1-2, the retransmission probability of initial transmission is determined based on the target BLER.

That is, the value of the retransmission probability of initial transmission is set based on the target BLER. Those skilled in the art can set the value of the target BLER according to actual needs, and it is not limited.

In optional step 1-3, the retransmission probability of the at least one UE is determined based on the number of times of initial transmission and the retransmission probability of initial transmission.

In an optional implementation, in the optional step 1-3, the retransmission probability Pᵤ of UEᵤ may be estimated by the following formula 1:

$${P}_{u} = 1 - {( 1 - {P}_{BLER}^{target} )}^{n} \qquad Formula 1$$

where n represents the number of times of using UEᵤ as initial transmission in the historical MU pairing recommendation result, P_{BLER}^{target} represents the retransmission probability of initial transmission, and the value of P_{BLER}^{target} is set based on the target BLER.

Thus, the retransmission probability may be estimated for each UE in the read historical MU pairing recommendation result, respectively.

In an embodiment, an optional implementation is provided for the step of “determining a first retransmission UE based on the retransmission probability of the at least one UE”. Specifically, this optional implementation may include: determining a retransmission validity threshold corresponding to the at least one UE; and, determining a first retransmission UE based on the retransmission probability of the at least one UE and the retransmission validity threshold corresponding to the at least one UE.

In an embodiment, the retransmission validity threshold may refer to a threshold used by the first network node to evaluate the retransmission validity of each retransmission JE.

Optionally, for one bundle in one period, the retransmission validity threshold corresponding to all UEs in the bundle may be determined, and the first retransmission UE may be determined based on the determined retransmission validity threshold of the bundle.

In an optional implementation, the retransmission validity threshold corresponding to at least one UE is determined according to historical scheduling information (historical sch. inf.). The historical scheduling information refers to the actual scheduling situation of the second network node in each first time unit in one or more past periods. That is, in an embodiment, the retransmission validity threshold corresponding to UEs in each bundle in the current period may be determined according to the historical scheduling information of one or more previous periods.

In an embodiment, in order to make the first retransmission UE predicted by the first network node consistent with the actual retransmission UE determined by the second network node as much as possible, an optional implementation (e.g., a validity strategy) is provided for the step of “determining the retransmission validity threshold corresponding to the at least one UE according to historical scheduling information”. For example, this optional implementation may include the following steps.

In optional step 2-1, a historical MU pairing recommendation result validity metric is determined according to the historical scheduling information.

The historical MU pairing recommendation result validity metric is used to measure the validity of retransmission UEs in the historical MU pairing recommendation result. Optionally, each bundle in a period has the corresponding historical MU pairing recommendation result validity metric. In an example, the historical MU pairing recommendation result validity metric corresponding to this bundle may be determined according to the historical scheduling information of one bundle. However, it is not limited thereto.

In an optional implementation, the historical scheduling information includes at least one of the following.

### (1) An MU-Scheduled First Time Unit.

That is, it may be determined whether each first time unit (e.g., TTI) is MU scheduled or not. MU scheduled or not may refer, for example, to whether the second network node uses the MU scheduling mode in the specified first time unit. If the MU scheduling mode is used, MU scheduled or not is set as Y; or MU scheduled or not is set as N.

(2) A First Time Unit in which the Second Network Node Determines the MU Pairing Recommendation Result.

That is, may be determined whether each first time unit (e.g., TTI) is a DU re-decided result, wherein the DU re-decided result may refer, for example, to the second network node not using the MU pairing recommendation result provided by the first network node in the specified first time unit and re-decides a new MU pairing recommendation result by itself. It is assumed that it is denoted by \hat{R}_{p′,b′,t′}^{DU}. That is, at the time corresponding to the (t′)^{th} first time unit of the (b′)^{th} bundle of the historical period p′, the second network node re-decides an MU pairing recommendation result.

(3) A First Time Unit in which the Second Network Node Uses the MU Pairing Recommendation Result Provided by the First Network Node.

That is, it may be determined whether the second network node (DU) uses the MU pairing recommendation result (MU-UE list) in each first time unit (e.g., TTI), wherein the second network node using the MU pairing recommendation result may refer, for example, to the second network node using the MU pairing recommendation result provided by the first network node in the specified first time unit. It is assumed that it is denoted by \hat{Q}_{p′,b′,t′}^{MU}. That is, at the time corresponding to the (t′)^{th} first time unit of the (b′)^{th} bundle of the historical period p′, the second network node uses the MU pairing recommendation result provided by the first network node.

For the convenience of understanding, the structure examples of the above historical scheduling information are shown in Table 1 below (in practical applications, it is not limited to these structures):

TABLE 1

| | | | MU | DU | |
|---|---|---|---|---|---|
| | | | scheduled | re-decided | MU-UE list used by |
| Historical sch. inf. | | | or not | result | DU |
| P′₁ | B′₁ | t′₁ | N | | |
| | | t′₂ | Y | | \hat{Q}_{1, 1, 2}^{MU} |
| | | . . . | . . . | . . . | . . . |
| | | t′_{N} | N | | |
| | . . . | . . . | . . . | . . . | . . . |
| | B′_{M} | t′₁ | Y | \hat{R}_{1, M, 1}^{DU} | |
| | | t′₂ | Y | | \hat{Q}_{1, M, 2}^{MU} |
| | | . . . | . . . | . . . | . . . |
| | | t′_{N} | N | | |
| P′₂ | B′₁ | t′₁ | Y | \hat{R}_{2, 1, 1}^{DU} | |
| | | t′₂ | Y | | \hat{Q}_{2, 1, 2}^{MU} |
| | | . . . | . . . | . . . | . . . |
| | | t′_{N} | N | | |
| | . . . | . . . | . . . | . . . | . . . |
| | B′_{M} | t′₁ | N | | |
| | | t′₂ | Y | \hat{R}_{2 ,M, 2}^{DU} | |
| | | . . . | . . . | . . . | . . . |
| | | t′_{N} | Y | | \hat{Q}_{2, M, N}^{MU} |
| . . . | . . . | . . . | . . . | . . . | . . . |
| P′_{T} | B′₁ | t′₁ | Y | | \hat{Q}_{T, 1, 1}^{MU} |
| | | t′₂ | Y | | \hat{Q}_{T, 1, 2}^{MU} |
| | | . . . | . . . | . . . | . . . |
| | | t′_{N} | N | | |
| | . . . | . . . | . . . | . . . | . . . |
| | B′_{M} | t′₁ | Y | \hat{R}_{T, M, 1}^{DU} | |
| | | t′₂ | Y | | \hat{Q}_{T, M, 2}^{MU} |
| | | . . . | . . . | . . . | . . . |
| | | t′_{N} | N | | |

where P′₁ to P′_{T} denote period indexes, B′₁ to B′_{M} denote bundle indexes, t′₁ to t′_{N} denote the indexes of first time units (e.g., TTIs) in each bundle, and there are total M×N first time units in one period.

In Table 1, the N in the column of MU scheduled or not indicates that MU scheduling is not performed in this first time unit (possibly because the single user (SU)-UE has a higher proportional fairness (PF) metric in this first time unit, but it is not limited thereto); and, Y indicates MU scheduling is performed in this first time unit. \hat{R}_{1,M,1}^{DU} indicates that the second network node does not use the MU pairing recommendation result provided by the first network node in the 1^{st} first time unit of the M^{th} bundle of the 1^{st} historical period and re-decides an MU pairing recommendation result (possibly because a certain retransmission UE is not in the MU pairing recommendation result provided by the first network node, but it is not limited thereto; and other \hat{R}_{p′,b′,t′}^{DU} is reasoned by analogy. \hat{Q}_{1,1,2}^{MU} indicates that the second network node uses the MU pairing recommendation result provided by the first network node in the 2^{nd} first time unit of the 1^{st} bundle of the 1^{st} historical period; and other \hat{Q}_{p′,b′,t′}^{MU} is reasoned by analogy.

Further, the historical scheduling information that can be determined based on this table may also include at least one of the following:

(4) The Actual Usage Condition of the MU Pairing Recommendation Result Provided by the First Network Node by the Second Network Node in Each First Time Unit Set of the historical period.

For example, the actual usage condition may include the following:
1) The number of first time units in each first time unit set of the historical period in which the second network node uses the MU pairing recommendation result provided by the first network node.

For example, in Table 1, in the 1^{st} bundle of the 1^{st} period, the first time units in which the second network node uses the MU pairing recommendation result provided by the first network node include t′₂ and other first time units in t′₂ to t′_{N}. According to the number of these first time units, the number of first time units in the 1^{st} bundle of the 1^{st} period in which the second network node uses the MU pairing recommendation result provided by the first network node may be determined. Other bundles are reasoned by analogy.
2) First time units in each first time unit set of the historical period in which the second network node uses the MU pairing recommendation result provided by the first network node may be determined, and the number of first time units among these first time units in which the first retransmission UEs provided by the first network node are more than the first retransmission UEs actually used by the second network node.

In practical applications, after the first network node provides the MU pairing recommendation result to the second network node, due to some specific UE related factors such as the PF metric or the usage condition of control channel resources, some first retransmission UEs in the MU pairing recommendation result are not MU scheduled. At this time, the first retransmission UEs provided by the first network node may be more than the first retransmission UEs actually used by the second network node, and the actual usage condition of the MU pairing recommendation result used by the second network node in each first time unit set of the historical period is used as the actual usage condition.

For example, first time units in each first time unit set of the historical period in which the second network node uses the MU pairing recommendation result provided by the first network node may be determined, and the number of first time units among these first time units in which the first retransmission UEs in Q_{p′,b′,t′}^{MU} are more than the first retransmission UEs in \hat{Q}_{p′,b′,t′}^{MU} is determined. Q_{p′,b′,t′}^{MU} may indicate the MU pairing recommendation result provided to the second network node by the first network node at the time corresponding to the (t′)^{th} first time unit of the (b′)^{th} bundle of the historical period p′, and \hat{Q}_{p′,b′,t′}^{MU}, may indicate the MU pairing recommendation result actually used by the second network node after the first network node provides the MU pairing recommendation result at this time. It can be known from the above description the number of first retransmission UEs in Q_{p′,b′,t′}^{MU} is greater than or equal to the number of first retransmission UEs in \hat{Q}_{p′,b′,t′}^{MU}.
(5) The number of first time units MU-scheduled by the second network node in each first time unit set of the historical period.

For example, in Table 1, in the M^{th} bundle of the 1^{st} period, the first time units MU-scheduled by the second network node includes t′₁, t′₂, and other first time units in t′₂ to t′_{N}. According to the number of these first time units, the number of first time units MU-scheduled by the second network node in the M^{th} bundle of the 1^{st} period may be determined. Other bundles may be reasoned by analogy.

In an optional implementation, by taking the first time unit being a TTI as an example, in the optional step 2-1, the historical MU pairing recommendation result validity metric Valid metric_{b} may be calculated based on the historical scheduling information by the following formula 2:

$$Formula 2$$

$$Valid {metric}_{{b}^{′}} = ( valid {time}_{{b}^{′}} - over valid {time}_{{b}^{′}} ) / sum number of TTI$$

where valid time_{b′} indicates the number of corresponding TTIs used by the second network node in the (b′)^{th} bundle in the MU pairing recommendation result provided by the first network node in the historical period; over valid times; indicates the number of corresponding TTIs used by the second network node in the MU pairing recommendation result provided by the first network node in the historical period, and the TTIs satisfy the condition that the first retransmission UEs in Q_{p′,b′,t′}^{MU} are more than the first retransmission UEs in \hat{Q}_{p′,b′,t′}^{MU}; and sum number of TTI indicates the sum number of corresponding TTIs MU-scheduled by the second network node in the (b′)^{th} bundle in the historical period.

Thus, the historical MU pairing recommendation result validity matric corresponding to each bundle may be calculated.

In optional step 2-2, a retransmission validity threshold corresponding to at least one UE in each first time unit set in the current period is determined according to the historical MU pairing recommendation result validity metric.

It can be known from the above description that each first time unit set (bundle) includes at least one first time unit in which HARQ feedback is performed on a same continuous UL second time unit.

As an example, the retransmission validity threshold corresponding to at least one UE in each bundle in the current period is determined according to the historical MU pairing recommendation result validity metric corresponding to one or more bundles.

In an embodiment, some implementations of this step may use a second AI network. That is, the retransmission validity threshold corresponding to at least one UE in each first time unit set in the current period is determined according to the historical scheduling information using the second AI network; or, the retransmission validity threshold corresponding to at least one UE in each first time unit set in the current period is determined according to the historical MU pairing recommendation result validity metric using the second AI network. In practical applications, those skilled in the art can set the specific AI network used in the steps according to the actual situation, and it is not limited in an embodiment.

In an optional implementation, the second AI network may adopt a E-greedy reinforcement learning network. That is, in an embodiment, the retransmission validity threshold may be determined and continuously optimized by E-greedy reinforcement learning according to the historical MU pairing recommendation result validity metric.

For example, in an embodiment, an optional implementation is provided for the optional step 2-2. For example, this optional implementation may include the following steps:

In optional step 2-2.1, the trained validity threshold set is acquired, the reward value corresponding to each validity threshold in the validity threshold set being determined according to the historical MU pairing recommendation result validity matric.

The validity threshold set may be trained in the following way.

In optional step 3-1, a preset validity threshold set, an exploration probability and the historical MU pairing recommendation result validity metric are acquired.

The initialized validity threshold set is assumed as [symbol] , for example, [symbol] ={0.01, 0.02, . . . , 1}, where a represents the value in the set [symbol] ; and, the exploration probability is assumed as ε. The historical MU pairing recommendation result validity metric is obtained from the optional step 2-1.

In optional step 3-2, the training steps in the following optional steps 3-2.1 to 3-2.4 are repeated until the reward value is converged to obtain the trained validity threshold set.

In optional step 3-2.1, a random value is generated for each first time unit set of at least one historical period, respectively.

For example, a random value is generated for the (b′)^{th} bundle of the period p′. Optionally, the value range of the random value may be, but not limited to, 0 to 1.

In optional step 3-2.2, if the random value is less than the exploration probability, a validity threshold is selected from the validity threshold set in a uniform distribution manner.

That is, if the random value is less than ε, the validity threshold Th_vaild_{b′}=a∈A, where a is randomly selected from the set [symbol] in a uniform distribution manner, and Th_vaild_{b′} represents the validity threshold of the (b′)^{th} bundle in one period.

In optional step 3-2.3, if the random value is greater than or equal to the exploration probability, the validity threshold corresponding to the largest reward in the validity threshold set is selected.

That is, if the random value is greater than or equal to ε, the validity threshold Th_vaild_{b′}=a, where a is a corresponding to the largest reward in the [symbol] , and [symbol] (a) represents the reward value corresponding to the validity threshold a in the validity threshold set.

In optional step 3-2.4, the reward value corresponding to the validity threshold selected from the validity threshold set is updated according to the historical MU pairing recommendation result validity metric corresponding to the historical period.

That is, the reward value [symbol] (a) of the selected a is updated according to the historical MU pairing recommendation result validity metric corresponding to (b′)^{th} bundle obtained after completing the scheduling in the period p′ in the second network node, that is: [symbol] (a)=(valid time_{b′}−over valid time_{b′})/sum number of TTI

### Formula 3

where valid times; indicates the number of corresponding TTIs used by the second network node in the (b′)^{th} bundle in the MU pairing recommendation result provided by the first network node in the historical period; over valid times; indicates the number of corresponding TTIs used by the second network node in the MU pairing recommendation result provided by the first network node in the historical period, and the TTIs satisfy the condition that the first retransmission UEs in Q_{p′,b′,t′}^{MU} are more than the first retransmission UEs in \hat{Q}_{p′,b′,t′}^{MU}; and sum number of TTI indicates the sum number of corresponding TTIs MU-scheduled by the second network node in the (b′)^{th} bundle in the historical period.

In other words, the validity threshold set in each period and the reward value of the validity threshold selected in this period will be continuously optimized and updated according to the historical scheduling information.

Thus, the trained validity threshold set can be obtained through the initialization and iteration of greedy reinforcement learning, and each validity threshold in the validity threshold set can learn the corresponding reward value.

In optional step 2-2.2, the validity threshold corresponding to the largest reward value in the validity threshold set is determined as the retransmission validity threshold corresponding to the at least one UE.

That is, for each bundle in the current period, the retransmission validity threshold Th_vaild_{b}=a corresponding to at least one UE in the bundle is selected, where a is a corresponding to the largest reward in the [symbol] . It should be understood that, in an embodiment, b′ represents the historical bundle (training data), and b represents the real-time bundle.

In an embodiment, after the optional step 2-2.2, the method may further include steps of: after the scheduling of the current period is completed, updating, according to the MU pairing recommendation result validity metric corresponding to the current period, the reward value corresponding to the retransmission validity threshold corresponding to at least one UE in the validity threshold set (e.g., continuously optimizing the validity threshold set) and the reward value of each validity threshold in the validity threshold set.

In an embodiment, the validity strategy is determined and continuously optimized according to the historical scheduling information by greedy reinforcement learning, so that the accuracy of the predicted first retransmission UE is ensured, and the validity of the MU pairing recommendation result provided by the first network node is further ensured.

In an embodiment, for the step S101, the first retransmission UE may be determined based on the retransmission probability of the at least one UE and the retransmission validity threshold corresponding to the at least one UE. That is, the first retransmission UE is determined according to the retransmission probability predicted in the first network node and based on the validity strategy. Specifically, the retransmission probability of the corresponding UE may be calculated according to the MU pairing recommendation result in the previous bundle and based on the target BLER, and then the first retransmission UE in the current bundle satisfying the retransmission validity threshold may be predicted according to the validity strategy.

In an optional implementation, this step may include: determining the first retransmission UE based on a comparison result of the retransmission probability of the at least one UE and the retransmission validity threshold corresponding to the at least one UE.

For example, the step of determining the first retransmission UE based on a comparison result of the retransmission probability of the at least one UE and the retransmission validity threshold corresponding to the at least one UE may include the following steps.

In step S101-1, the at least one UE is sorted in the order from smallest to largest retransmission probabilities.

As an example, for UEs in the MU pairing recommendation result of the previous bundle (e.g., the above bundle b−1), the UEs, are sorted according to the calculated retransmission probability.

In step S101-2, the following operation is successively performed on the sorted at least one UE until a target UE is determined: determining a cumulative retransmission probability of a UE and UEs before this UE, determining the corresponding retransmission validity probability based on the cumulative retransmission probability, and determining this UE as a target UE if the retransmission validity probability is less than the retransmission validity threshold.

The retransmission validity may refer to the reverse probability of the cumulative retransmission probability, or may be calculated in combination with a certain weight.

According to the sorted UEs, starting from the UE with the smallest retransmission probability, it is cumulatively evaluated and judged, according to the validity threshold Th_valid_{b} corresponding to the bundle b, whether each UE is a virtual retransmission UE.

TABLE 2

| | | Retransmission |
|---|---|---|
| Sort | UE | probability |
| 1 | UE3 | 0.001 |
| 2 | UE5 | 0.002 |
| 3 | UE4 | 0.3 |
| 4 | UE1 | 0.35 |
| . . . | . . . | . . . |

In an example, the sorted at least UE and the retransmission probability are shown in Table 2. It is assumed that the validity threshold Th_valid_{b} corresponding to the bundle b is equal to 0.8, Th_valid_{b}=0.8. By taking the retransmission validity probability being the reverse probability of the cumulative retransmission probability as an example, the reverse probability of the retransmission probability of the first UE is 1−0.001=0.999; the reverse probability of the sum of the retransmission probabilities of first two UEs is 1−(0.001+0.002)−0.997; and, the reverse probability of the sum of the retransmission probabilities of first three UEs is 1−(0.001+0.002+0.3)−0.697. Wherein, 0.697<0.8, and 0.997≥0.8. Thus, the target UE is the third UE.

In step S101-3, the target UE and UEs after the target UE are determined as first retransmission UEs.

Continuing with the above example, all UEs from the third UE may be determined as first retransmission UEs, which may be included in the first retransmission UE list.

Thus, all first retransmission UE (or the first retransmission UE list) may be determined.

In an optional implementation, in the step S101-2, the retransmission validity probability value virtual may be calculated starting from the UE with the smallest retransmission probability by the following formula 4:

$${V}_{b}^{virtual} = 1 - {\sum }_{u ∉ {R}_{m , b , t}^{V}} {P}_{u} \qquad Formula 4$$

where u represents the sort number of the UE, and R_{m,b,t}^{V} represents the first retransmission UE list at the time corresponding to the t^{th} first time unit (e.g., TTI) of the b^{th} bundle of the corresponding period m. It should be understood that, when u=1, the UE set of the current u∉R_{m,b,t}^{V} includes the first UE; when u=2, the UE set of the current u∉R_{m,b,t}^{V} includes the first UE and the second UE; and so on.

In an optional implementation, the operation process of the steps S101-1 to S101-3 may be expressed in the following way.

The following evaluation operation is successively performed on the UEu=1, 2, . . . , U: evaluating the validity (retransmission validity probability of the bundle b: V_{b}^{virtual}=1−Σ_{u∉R}_{_{m,b,t}}_{^{V}} Pᵤ; if V_{b}^{virtual}≥Th_valid_{b}, determining that the UEu is not the first retransmission UE, that is, u∉R_{m,b,t}^{V}; or, determining UEs from UEu to UEu as first retransmission UEs, and ending the evaluation of subsequent UEs.

In an embodiment, since the error probability of chase combining (CC, a retransmission mode) after retransmission is relatively low, the retransmission probability of the first retransmission UE can be omitted.

In an embodiment, the first retransmission UE list of the bundle b may be calculated according to the MU pairing recommendation result of the bundle b−1. In an example, it is assumed that the MU pairing recommendation result of the bundle b−1 is shown in Table 3:

TABLE 3

| | B_{b-1} | | | |
|---|---|---|---|---|
| Time | t₁ | t₂ | . . . | t_{N} |
| Mu pairing | Q_{p, b-1, 1}^{MU} | Q_{p, b-1, 2}^{MU} | . . . | Q_{p, b-1, N}^{MU} |
| recommendation | | | | |
| result | | | | |
| 1st layer | UE1 | UE3 | . . . | UE7 |
| 2nd layer | UE2 | UE4 | . . . | UE8 |
| 3rd layer | UE3 | UE1 | . . . | UE1 |
| 4th layer | UE4 | UE5 | . . . | UE2 |

where Q_{p,b-1,n}^{MU} represents the n^{th} first time unit of the bundle b−1 of the period p, and the 4th layer indicates that the maximum number of UEs in the MU pairing recommendation result in this example is restricted as 4. In the MU pairing recommendation result of the bundle b−1, some UEs (e.g., UE1 and UE2) are first retransmission UEs of the bundle b−1, and other UEs are initial transmission UEs of the bundle b−1.

Based on at least one of the above examples, the first retransmission UE list of the bundle b shown in Table 4 may be determined according to the MU pairing recommendation result of the bundle b−1:

TABLE 4

B_{b}

| Time | t₁ | t₂ | . . . | t_{N} |
|---|---|---|---|---|
| First retransmission UE list | R_{p, b, 1}^{V} | R_{p, b, 2}^{V} | . . . | . . . |
| UE index of the 1st layer | UE7 | UE3 | | |
| UE index of the 2nd layer | UE6 | | | |
| UE index of the 3rd layer | UE4 | | | |
| UE index of the 4th layer | UE8 | | | |

where R_{p,b,n}^{V} represents the n^{th} first time unit of the bundle b of the period p, and the 4th layer indicates that the maximum number of UEs in the MU pairing recommendation result in this example is restricted as 4. In the first retransmission UE list of the bundle b, each UE is the first retransmission UE.

It is to be noted that, the number of layers and the corresponding UEs shown in Table 3 and Table 4 are only illustrative, and the specific first retransmission UE list is subject to the actual implementation. The examples of the number of layers and the corresponding UEs shown in Table 3 and Table 4 should not be interpreted as any limitations to the present disclosure. For example, the number of layers used in practical applications may be far greater than 4. For another example, one UE may correspond to multiple layers (that is, different layers may correspond to the same UE index). For still another example, the number of layers corresponding to different first time units may be different. It is not limited in an embodiment.

In the technical aspects of various embodiments, the retransmission probabilities of UEs are calculated based on the target BLER and a first retransmission UE is then determined according to the retransmission probabilities of UEs and the validity strategy, so that the accuracy of the predicted first retransmission UE is ensured, the actual retransmission UE of the second network node during real-time scheduling is ensured to be in the MU pairing recommendation result predicted by the first network node, and the validity of the MU pairing recommendation result is ensured.

In addition, according to the transmission timing relationship between data and HARQ ACK/NACK feedback, the first time units (e.g., TTIs) in one period are divided into bundles, so that all retransmission UEs of a certain bundle are retransmitted and scheduled in this period, and it is advantageous to predict retransmission UEs and schedule retransmission UEs in time.

In an embodiment, an optional implementation is also provided for the step S102. For example, this optional implementation may include the following steps.

In step S102-1, at least one candidate UE is determined according to the amount of data to be transmitted of UEs and measurement configuration information.

In an embodiment, the data amount of data to be transmitted may be determined by predicting the buffer occupy (BO).

In order to obtain UEs to be scheduled, the first network node may remove, according to the predicted BO of each UE and the UE measurement configuration information (UE meas. Conf.), UEs that cannot be scheduled in each first time unit, so as to generate at least one candidate UE of each first time unit in a period.

The amount of data to be transmitted or the predicted BO may be provided by the service prediction xAPP (applications in the first network node) of the first network node, and may be derived from report data of events or periodic report data. The measurement configuration information (UE meas. Conf.) may be derived from the periodic report data of the second network node. The measurement configuration information is the configuration information provided by the second network node to the UE to configure a measurement GAP. It can be known through the measurement configuration information that a period of time (e.g., a measurement gap GAP) is reserved for measurement. The UE will not transmit or receive any data in this period of time, so the base station will also not schedule this UE in this period of time.

For example, it is possible to first determine initial candidate UEs, then delete, from the initial candidate UEs, candidates UEs whose the amount of data to be transmitted is less than a first threshold, and delete, from the initial candidate UEs, candidate UEs in measurement gaps according to the measurement configuration information, to obtain at least one candidate UE.

That is, in an embodiment, by taking the first time unit being a TTI as an example, at least one candidate UE may be generated by using the predicted TTI-level UE scheduling restriction criterion. The criterion includes the following:
1) In the given TTI, the UE(s) without service is determined according to whether the predicted BO being less than the first threshold, and the UE(s) cannot be scheduled in this TTI.
2) The TTI corresponding to the measurement gap of a UE is obtained according to the UE measurement configuration information (UE meas. Conf.). When a UE is in the measurement gap, this UE cannot be scheduled in this TTI.

As an example, Table shows examples of some initial candidate UEs:

TABLE 5

| UE list | TTI_1 | TTI_2 | TTI_3 | TTI_4 | TTI_5 | TTI_6 | TTI_7 | . . . | TTI_M × N |
|---|---|---|---|---|---|---|---|---|---|
| UE1 | | X1 | | | . . . | X1 | X1 | . . . | X1 |
| UE2 | | X1 | X2 | X2 | X1 | | | . . . | |
| . . . | . . . | . . . | . . . | . . . | . . . | . . . | . . . | . . . | . . . |
| UE L | | | | X1 | X1 | | | . . . | |

where UE1 to UE L represent UE indexes, and L represents the total number of UEs with service in the current period; and, TTI_1 to TTI_M×N represent TTI indexes, and M×N represents the total number of TTIs in the current period. X1 indicates that the corresponding UE has no service in the corresponding TTI and may be determined according to the predicted BO being less than the first threshold, and these UEs are deleted from the corresponding TTIs of the initial candidate UE list. X2 indicates that the corresponding UE is in the measurement gap in the corresponding TTI and may be determined according to the measurement configuration (UE meas. Conf.), and these UEs are deleted from the corresponding TTIs of the initial candidate UE list.

It is to be noted that, the initial candidate UEs, the UE that cannot be scheduled in the corresponding TTI and the identifiers (X1 and X2) of the reasons why it cannot be scheduled are only illustrative, the specific list of initial candidate UEs is subject to actual implementation, and the representations in Table 5 should not be interpreted as limitations to the present disclosure. For example, in practical applications, the number of UEs corresponding to different TTIs may be different. For another example, each UE may be identified as “candidate” or “non-candidate” in each TTI (the identifier may be set by those skilled in the art according to the actual situation). For another example, the initial candidate UE list is represented by an increment UE list or a decrement UE list of the preset UE list. It is not limited in an embodiment. Similarly, the determined at least one candidate UE may be processed in the form of a list. That is, in this step, the candidate UE list may be directly determined.

In step S102-2, the MU pairing recommendation result is determined using the first AI network based on the first retransmission UE and the at least one candidate UE.

That is, in an embodiment, in addition to the first retransmission UE predicted by the first network node, the determined MU pairing recommendation result also includes the corresponding UE to be scheduled for MU pairing in each first time unit in a period, thereby ensuring that the MU pairing recommendation result provided by the first network node is valid for the final MU transmission.

In an embodiment, it is also possible to add a fairness operation based on the step S102-1. For example, the step S102-1 may include: determining at least one candidate UE according to the amount of data to be transmitted of UEs, the measurement configuration information and a UE scheduling parameter.

For example, it is possible to determine initial candidate UEs, then delete, from the initial candidate UEs, candidate UEs whose the amount of data to be transmitted is less than the first threshold, delete, from the initial candidate UEs, candidate UEs in measurement gaps according to the measurement configuration information, and sort the initial candidate UEs according to the UE scheduling parameter and/or delete, from the initial candidate UEs, candidate UEs whose the UE scheduling parameter is greater than a fairness threshold, to obtain at least one candidate UE.

The UE scheduling parameter (also referred to as a normalized UE scheduling ratio) is determined according to the number of first time units in which UEs satisfy a preset condition in a preset period of time including a plurality of first time units. In an example, the preset condition may refer, for example, to the amount of data to be transmitted being greater than or equal to the first threshold (or the BO is greater than or equal to a BO threshold) and it is out of the measurement gap, etc., but it is not limited thereto.

In an optional implementation, by taking the first time unit being a TTI as an example, the UE scheduling parameter may be calculated by the following formula 5:

$$Formula 5$$

$$Normalized UE scheduling ratioi = Scheduling TTI numberi / TTI number with enough BO and out of M - gap$$

where Scheduling TTI numberi represents the number of TTIs of the scheduled UEi in a period of counting time (e.g., a preset period of time, including a plurality of TTIs) that satisfies the conditions that the amount of data to be transmitted of the UEi is greater than or equal to the first threshold (or the BO is greater than or equal to the BO threshold) and it is out of the measurement gap; and, TTI number with enough BO and out of M-gap represents the sum number of TTIs of all UEs in a period of counting time (e.g., a preset period of time, including a plurality of TTIs) that satisfy the conditions that the amount of data to be transmitted is greater than or equal to the first threshold (or the BO is greater than or equal to the BO threshold) and it is out of the measurement gap.

For the convenience of understanding, a specific example of the process of generating the candidate UE list will be given below.

In step 1), the candidate UE list is initialized, and the candidate UE list includes L UEs (e.g., UE1, UE2, . . . , UEL) in each TTI.

In step 2), the BO value corresponding to each UE in each TTI is obtained according to the predicted BO; and, if the BO value corresponding to a certain UE in a certain TTI is less than the BO threshold (e.g., the first threshold), this UE is not included in the candidate UE list in the corresponding TTI, and this UE is deleted from the UE list of the candidate UE list in the corresponding TTI.

In step 3), the TTI corresponding to the measurement gap of each UE is obtained according to the UE measurement configuration information (UE meas. Conf.); and, if a certain UE is in the measurement gap in a certain TTI, this UE is not included in the candidate UE list in the corresponding TTI, and this UE is deleted from the UE list of the candidate UE list in the corresponding TTI.

In step 4) (optionally), the UE scheduling parameter of each UE is calculated; if the UE scheduling parameter of a certain UE is greater than the fairness threshold, this UE is deleted from the candidate UE list, specifically deleting this UE from the UE list including this UE in the corresponding TTI; and/or, UEs are sorted in the order from the smallest to largest UE scheduling parameters, and UE with larger UE scheduling parameters are moved to the tail of the queue.

In step 5), according to the TTI-level UE scheduling restriction criterion in the steps 2) and 3) and/or the fairness operation in the step 4), UEs that cannot be scheduled in each TTI in a period are screened out to finally generate the candidate UE list.

In an embodiment, by performing additional operations on the candidate UE list, the candidate UE list does not include the UEs whose the amount of data to be transmitted is less than the first threshold value and which are in the measurement gap, that is, the UEs having more scheduling opportunities are deleted from the candidate UE list, so that the UEs having good channel conditions and less multi-user interference from other UEs are prevented or inhibited from being frequently selected to the MU pairing recommendation result based on the maximum throughput criterion, and the UEs can get scheduling opportunities more fairly. Accordingly, the phenomenon that some UEs are allocated with excessive resources and over-saturated because they get more scheduling opportunities while some UEs are allocated with too few resources and starved because they get very little scheduling opportunities is avoided. By preliminarily screening the candidate UE list, the validity of the MU pairing recommendation result is further ensured.

In an embodiment, an optional implementation is provided for the step S102-2. For example, this optional implementation may include: determining the MU pairing recommendation result using the first AI network based on the first retransmission UE, the at least one candidate UE and at least one of the following:
(1) a predicted signal to interference plus noise ratio (SINR);

wherein the predicted SINR may come from other xAPP (the application in the first network node);
(2) a predicted H_sounding reference signal (H_SRS);
wherein the predicted H_SRS may also come from other xAPP;
(3) uplink/downlink slot configuration information (UD Conf.); and
(4) HARQ related configuration information (HARQ conf.).

For example, the first network node determines the MU pairing recommendation result of each TTI in a bundle according to the predicted first retransmission UE list (virtual Re-Tx UE list), the candidate UE list, the predicted SINR and the predicted H_SRS using the first AI network (e.g., a deep learning neural network, but it is not limited thereto), so that the MU pairing recommendation result of each TTI in a period is finally obtained.

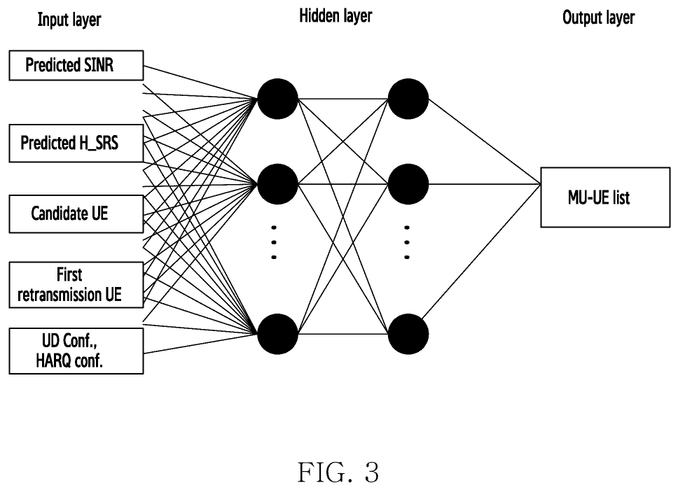

For another example, as shown in FIG. 3, the first network node determines the MU pairing recommendation result using the first AI network (e.g., a deep learning neural network including at least one hidden layer, but it is not limited thereto). The input layer incudes the predicted first retransmission UE list (virtual Re-Tx UE list), the candidate UE list (candidate UE list), the predicted SINR, the predicted H_SRS, the uplink/downlink slot configuration information (UD Conf.) and the HARQ related configuration information (HARQ conf.), and the output layer includes the MU-UE list (e.g., the MU pairing recommendation result) of each TTI in each bundle. Thus, the MU-UE list (e.g., the MU pairing recommendation result) of each TTI in a period is finally obtained.

In an embodiment, the first AI network may determine the MU pairing recommendation result according to the maximum throughput criterion.

In an optional implementation, the first AI network may determine the MU pairing recommendation result based on the goal of maximizing/increasing the multi-user-modulation order product code rate (MU-MPR) and sum MU-MPR of at least one UE. That is, the method in an embodiment further includes: training the first AI network to maximize/increase the sum MU-MPR of the at least one UE. Optionally, the first AI network is trained using predetermined tag data by a greedy search method. By maximizing/increasing the sum MU-MRP, the throughput of the system is improved.

The MU-MRP of each UE is determined according to at least one of the following: the predicted SINR of the UE; and, the multi-user beam forming (MU BF) weight determined based on the predicted H-SRS.

In an optional implementation, the MU-MRP of one UEu may be calculated by the following formula 6 and formula 7:

$${MPR}_{u}^{MU} = SIN {R}_{u} + {mu\_loss}_{u} \qquad Formula 6$$

$${mu\_loss}_{u} = \frac{1}{‖ {W}_{u} ‖} \qquad Formula 7$$

where Wᵤ represents the MU BF weight calculated according to the predicted H_SRS, mu_lossᵤ represents the MU loss caused by multi-user interference, and SINRᵤ represents the predicted SINR of the UEu.

In an embodiment, the MU pairing result (as shown in Table 8 below) of each TTI of the bundle b may be calculated according to the first retransmission UE list (as shown in Table 6 below) of the bundle b and the candidate UE list (as shown in Table 7 below) of the bundle b.

TABLE 6

| | B_{b} | | | |
|---|---|---|---|---|
| Time | t₁ | t₂ | . . . | t_{N} |
| First retransmission UE list | R_{p, b, 1}^{V} | R_{p, b, 2}^{V} | . . . | R_{p, b, N}^{V} |
| UE index of the 1^{st} layer | UE1 | UE3 | . . . | |
| UE index of the 2^{nd} layer | UE2 | | . . . | |
| UE index of the 3^{rd} layer | UE4 | | . . . | |
| UE index of the 4^{th} layer | UE8 | | . . . | |

TABLE 7

| Candidate UE list | t₁ | t₂ | . . . | t_{N} |
|---|---|---|---|---|
| UE1 | | X1 | | |
| UE2 | | X1 | . . . | X2 |
| . . . | . . . | . . . | . . . | . . . |
| UE L | | | | X1 |

TABLE 8

| | B_{b} | | | |
|---|---|---|---|---|
| Time | t₁ | t₂ | . . . | t_{N} |
| MU pairing | Q_{p, b, 1}^{MU} | Q_{p, b, 2}^{MU} | . . . | Q_{p, b, N}^{MU} |
| recommendation result | | | | |
| 1^{st} layer | UE1 | UE3 | . . . | UE 1 |
| 2^{nd} layer | UE2 | UE4 | . . . | UE7 |
| 3^{rd} layer | UE4 | UE7 | . . . | UE9 |
| 4^{th} layer | UE8 | UE10 | . . . | UE8 |

The specific content of Table 6 may refer to the above description of Table 4, and the specific content of Table 7 may refer to the above description of Table 5. It will not be repeated here.

In Table 8, Q_{p,b,n}^{MU} represents the n^{th} TTI of the bundle b of the period p, and the 4^{th} layer indicates that the maximum number of UEs in the MU pairing recommendation result in this example is restricted as 4. In the MU pairing recommendation result of the bundle b, each UE is selected by the first AI network. The UEs at t₁ and the UE3 at t₂ are retransmission UEs, and other UEs are initial transmission UEs.

It is also to be noted that, the number of layers and the corresponding UEs shown in Table 8 are only illustrative, and the specific MU pairing recommendation result is subject to the actual implementation. The examples of the number of layers and the corresponding UEs shown in Table 8 should not be interpreted as any limitations to the present disclosure. For example, the number of layers used in practical applications may be far greater than 4. For another example, one UE may correspond to multiple layers. For still another example, the number of layers corresponding to different TTIs may be different. For yet another example, some UEs may be associated UEs. It is not limited in an embodiment of the present disclosure.

Thus, the MU pairing recommendation result of each first time unit (e.g., TTI) of each bundle may be obtained. The first network node integrates the MU-UE list of each first time unit of all bundles in a period, and transmits the integrated MU pairing recommendation result to the second network node in the step S103.

In the disclosure, in order to address the retransmission delay problem and improve the cell throughput, the MU pairing recommendation result including retransmission UEs determined based on the AI network by the first network node is provided to assist the computation of the intelligent massive MIMO scheduler of the second network node, thereby ensuring the system performance.

In an embodiment, considering the computation capability (also referred to as computing power) of the second network node and the complexity of MU scheduling in the second network node, the next generation node B (gNB) may selectively execute the scheme of the present disclosure according to the computation capability of the second network node. That is, the step S101 may include: acquiring the computation capability of the second network node; and, determining the first retransmission UE when the computation capability is less than a predetermined condition. The computation capability of the second network node may be determined according to the hardware information of the second network node, the historical computation information of the second network node, etc., but it is not limited thereto.

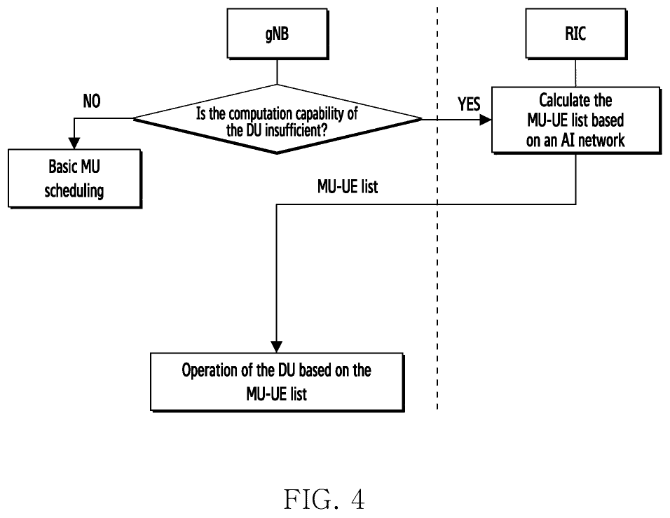

In an optional example, by taking the first network node being an RIC and the second network node being a DU as an example, the gNB may switch between the scheme of the present disclosure and the existing scheme of the DU according to the computation capability of the DU, as shown in FIG. 4. If the computation capability of the DU is insufficient, the gNB switches to the scheme of the present disclosure. That is, the RIC calculates an MU-UE list (e.g., an MU pairing recommendation result) using an AI network and then transmits the MU-UE list to the DU, and the DU performs MU scheduling according to the MU-UE list. Since the RIC determines a first retransmission UE according to the retransmission probabilities of UEs and the validity strategy and then determines the MU-UE list according to the first retransmission UE, it is ensured that the first retransmission UE can be included in the MU-UE list. Otherwise, the gNB uses the exciting basic MU scheduling scheme in the DU.

Further, after the MU pairing recommendation result generated by the network node through the AI network is transmitted to the second network node, the second network node may also determine, according to a certain principle, whether to use the MU pairing recommendation result provided by the first network node to perform MU scheduling. The principle is that: for each first time unit, if there is no actual retransmission UE in this first time unit or there are actual retransmission UEs in the first time unit and the actual retransmission UEs are (possibly all, or at a certain proportion, or at a set number) included in the MU-UE list provided by the first network node, the MU pairing recommendation result provided by the first network node is used for MU scheduling. Specifically, the reference can be made to the following description of the method executed on the second network node side.

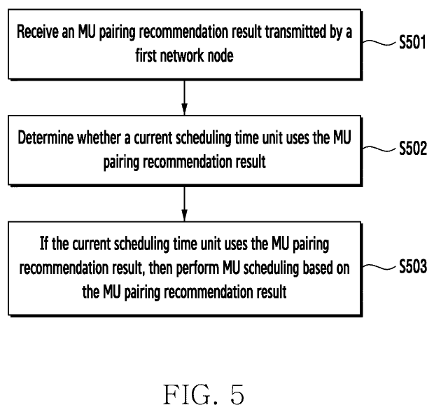

An embodiment further provides a method executed by a second network node in a communication system. As shown in FIG. 5, the method may include the following steps.

In step S501, an MU pairing recommendation result transmitted by a first network node is received.

In step S502, it is determined whether a current scheduling time unit uses the MU pairing recommendation result.

The current scheduling time unit may refer to the currently scheduled first time unit, but it is not limited thereto.

In an optional implementation, a second transmission UE of the current scheduling time unit may be determined according to the HARQ (ACK/NACK) feedback, wherein the second retransmission UE refers to a retransmission UE determined by the second network node and may also be referred to as an actual retransmission UE (actual Re-Tx UE).

Further, if there is no second retransmission UE in the current scheduling time unit or the second retransmission UE is included in the MU pairing recommendation result corresponding to the current scheduling time unit, it is determined that the current scheduling time unit uses the MU pairing recommendation result provided by the first network node; or, it is determined that the current scheduling time unit does not use the MU pairing recommendation result provided by the first network node.

The second retransmission UE being included in the MU pairing recommendation result corresponding to the current scheduling time unit may refer, for example, to all second retransmission UEs being included in the MU pairing recommendation result, or a certain percentage of the second retransmission UEs are included in the MU pairing recommendation result, or a set number of second retransmission UEs are included in the MU pairing recommendation result. Those skilled in the art can set according to the actual situation, and it is not limited in an embodiment of the present disclosure.

In step S503, if the current scheduling time unit uses the MU pairing recommendation result, MU scheduling is performed based on the MU pairing recommendation result.

The MU scheduling operation includes, but not limited to, MU layer decision, resource allocation, etc.

Similarly, the first network node may be an RIC, and the second network node may be a DU. However, the disclosure is not limited thereto.

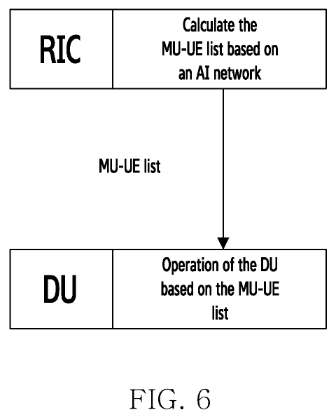

As an example, as shown in FIG. 6, the RIC calculates the MU-UE list (e.g., the MU pairing recommendation result) of each TTI in a next period based on the AI network, and the DU receives the MU-UE list of each TTI in one period provided by the RIC. The mMIMO scheduler in the DU determines whether to use the MU-UE list of the corresponding TTI provided by the RIC in each scheduling time unit (e.g., corresponding TTI), and performs corresponding MU layer decision and resource allocation.

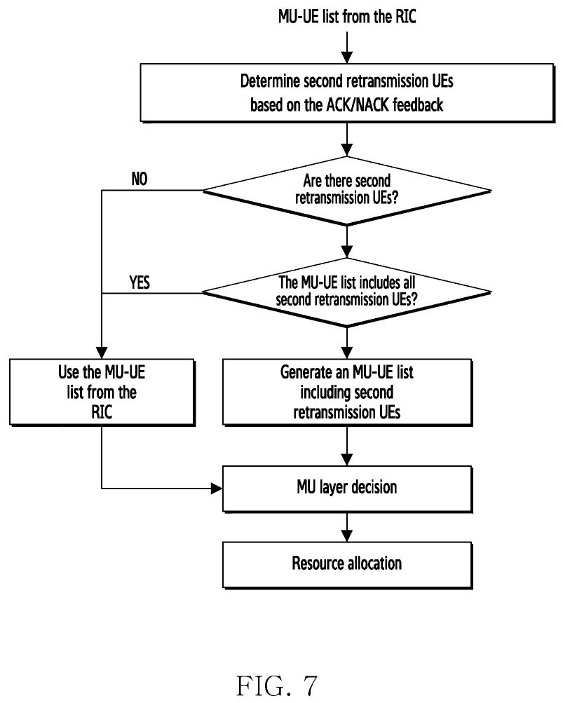

In an example, an operation process of the DU (e.g., second network node) may be shown in FIG. 7, and may include the following steps.

For each scheduling time unit, the DU determines the second retransmission UE (actual retransmission UE) of the corresponding scheduling time unit according to the HARQ ACK/NACK feedback. If there is no second retransmission UE in this time unit, the MU-UE list (e.g., the MU pairing recommendation result) corresponding to this time unit provided by the RIC is directly used; or, then it is determined whether the existing second retransmission UEs are all (or it may be replaced with other inclusion conditions) included in the MU-UE list corresponding to this time unit provided by the RIC. If yes, the MU-UE list provided by the RIC is directly used; or, the MU-UE list provided by the RIC is not used, and the DU generates the MU-UE list of this time unit according to the second retransmission UEs. Then, MU layer decision and resource allocation are performed, and MU scheduling is finally completed.

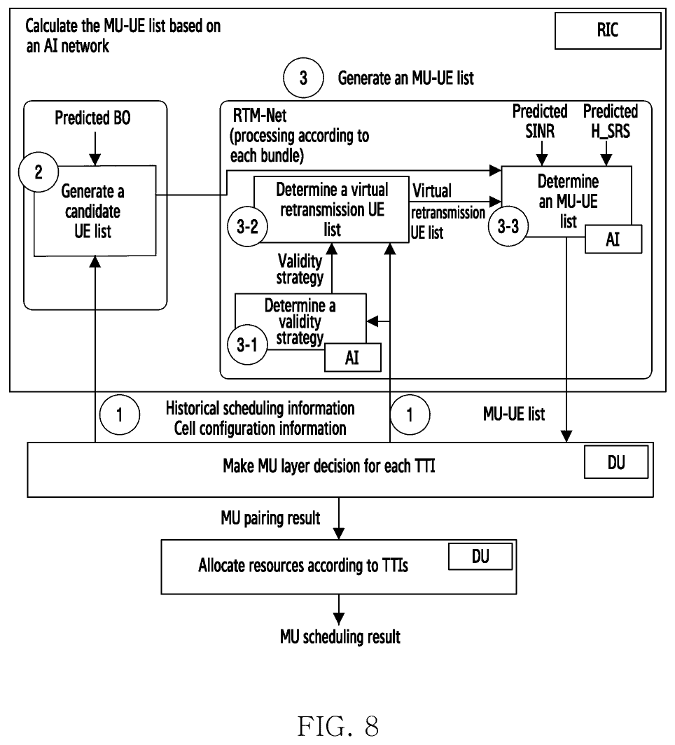

Based on at least one of the above examples, in an embodiment, FIG. 8 shows a complete process of the scheme of the present disclosure. The whole MU scheduling is jointly completed by the RIC (first network node) and the DU (second network node). The RIC determines the MU-UE list (MU pairing recommendation result) including retransmission UEs, and the scheduler of the DU completes MU layer decision and resource allocation according to the MU-UE list. The process mainly includes the following steps.

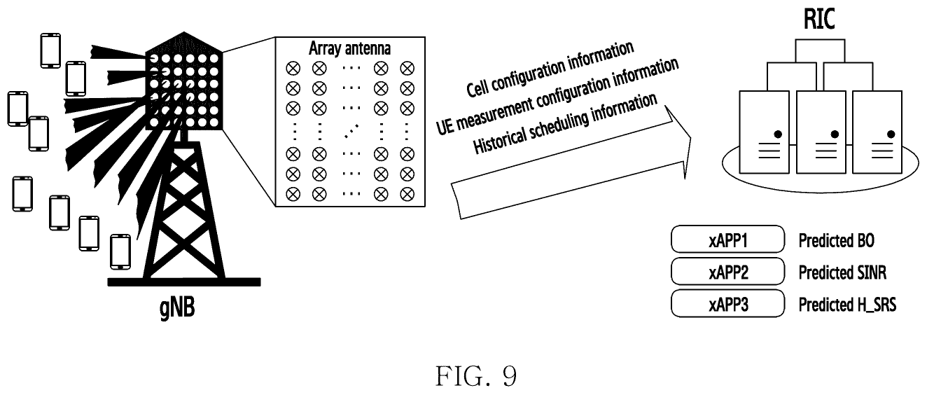

In step 8-1 (“8-” is omitted in FIG. 8, the same as in subsequent steps, which will not be repeated), information is collected. As shown in FIG. 9, the gNB includes an antenna array, and transmits and receives data through the mMIMO. The RIC periodically collects information, including but not limited to, receiving UE measurement configuration information (UE meas. Conf., used for determining candidate UEs), cell configuration information (cell conf. Inf. or Cell basic conf. Inf., including but not limited to uplink/downlink slot configuration information, HARQ related configuration information, etc., used for determining bundle related information) and historical scheduling information (historical sch. Inf., including but not limited to the scheduling UE list, ACK/NACK feedback, etc., used for calculating historical validity data and determining the validity strategy) from the gNB, and acquiring report data (including but not limited to, the predicted BO (used for generating candidate UEs), the predicted SINR (used for generating the MU-UE list), the predicted H_SRS (used for generating the MU-UE list), etc.) from the xAPP. This step is mainly to collect the data regularly reported by the gNB DU and the RI to prepare for the calculation of the MU-UE list.

In step 8-2, a candidate UE list is generated. According to the predicted BO of each UE and the UE measurement configuration information (UE meas. Conf.), the RIC removes UEs that cannot be scheduled in each TTI (first time unit) to generate a candidate UE list of each TTI in one period.

Optionally, considering the fairness of users, an additional operation on fairness is provided based on the step 8-2. That is, the UE scheduling parameter of each UE is calculated; and, if the UE scheduling parameter of a UE is greater than the fairness threshold, this UE is deleted from the candidate UE list.

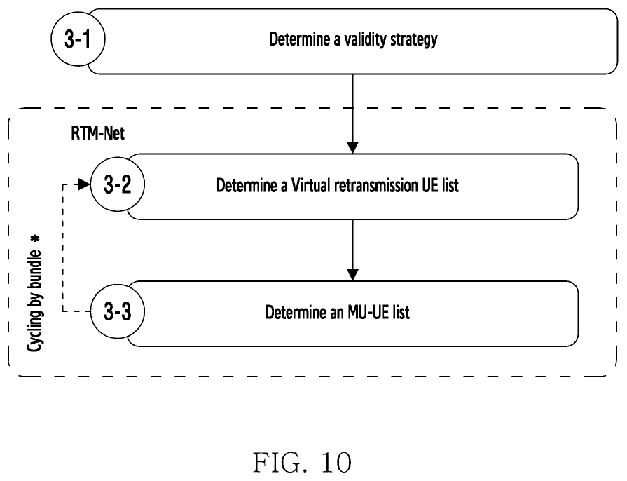

In step 8-3, an MU-UE list (used for selecting MU pairing UEs) is generated. Optionally, as shown in FIG. 10, the MU-UE list of each TTI in one period is determined by the following three steps.

In step 8-3-1, a validity strategy is determined. The validity strategy is set according to the historical scheduling information (historical sch. Inf.). The validity strategy is to determine and continuously optimize the retransmission validity threshold (Th_vaild_{b}) by E-greedy reinforcement learning to ensure that the MU-UE list provided by the RIC can include the actual retransmission UE (actual Re-Tx UE, e.g., the second retransmission UE) determined by the DU.

In step 8-3-2, a virtual retransmission UE list (virtual Re-Tx UE list, e.g., the first retransmission UE list) is determined. The retransmission probabilities of UEs are calculated according to the previously generated MU-UE list and the target BLER, and the virtual retransmission UE list is then predicted according to the validity strategy, thereby ensuring that the retransmission UE can be included in the MU-UE list.

In step 8-3-3, an MU-UE list is determined. According to the predicted virtual retransmission UE list (virtual Re-Tx UE list), the candidate UE list, the predicted SINR and the predicted H_SRS, the RIC determines an MU-UE list according to the maximum throughput criterion using a deep learning neural network, so that the MU-UE list of each TTI in one period is finally obtained.

It is to be noted that the period refers to the time interval of information exchange between the RIC and the DU, usually tens or hundreds of milliseconds. In order to enable the RIC to predict retransmission UEs in real time and provide a more valid MU pairing result, the whole period is divided into a plurality of bundles in an embodiment. According to the transmission timing relationship between data and HARQ ACK/NACK feedback, TTIs in one period are clustered to obtain each bundle. The HARQ ACK/NACK of each TTI in each bundle is fed back on the same continuous uplink slot. Therefore, the steps 8-3-2 and 8-3-3 may be the processing executed according to each bundle cycle in one period. In addition, in order to retransmit and schedule all required retransmission UEs in each bundle in this period, the validity strategy in the step 8-3-1 is set for the bundle in an embodiment.

In practical applications, the steps 8-3-2 and 8-3-3 may be the specific implementation steps of the maximum throughput with restriction network (RTM-net). The RTM-Net is a semi-supervised clustering machine learning interlaced with a deep learning neural network to maximize/increase the MU-MPR, and is used to determine the MU-UE list of each TTI in each bundle according to the maximum throughput criterion so that the MU-UE list can include retransmission UEs.

By the above steps, the RIC can eventually generate the MU-UE list of each TTI of the next period and transmit it to the DU.

The scheduler in the DU determines whether to use the MU-UE list provided by the RIC, and performs MU layer decision and resource allocation. Finally, MU scheduling is completed.

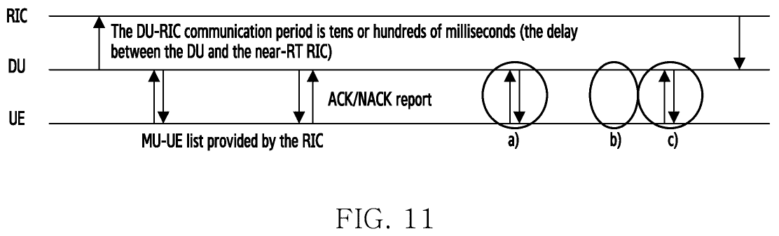

In an embodiment, the operation of the DU (second network node) based on the MU-UE list (MU pairing recommendation result) is shown in FIG. 11. Due to the delay (usually the DU-RIC communication period of tens or hundreds of milliseconds between the DU and the near-real time (near-RT) RIC (first network node), the RIC cannot acquire the HARQ ACK/NACK information in time. Thus, once a UE feeds back NACK, the DU should schedule retransmission immediately, and the DU uses the MU list provided by the RIC to assist scheduling. This may be implemented in the following way: for each scheduling time unit, the DU determines actual retransmission UEs according to the ACK/NACK feedback. If there is no actual retransmission UE or all actual retransmission UEs are included in the MU-UE list provided by the RIC, the MU-UE list provided by the RIC is directly used; or, the DU generates an MU-UE list according to the actual retransmission UEs.

As an example, it is assumed that the MU-UE list of the bundle b and bundle b+1 provided by the RIC is shown in Table 9:

TABLE 9

| | Time | | | | | | | |
|---|---|---|---|---|---|---|---|---|
| | B_{b} | | | | B_{b+1} | | | |
| | t₁ | t₂ | . . . | t_{N} | t₁ | t₂ | . . . | t_{N} |
| MU-UE list | Q_{p, b, 1}^{MU} | Q_{p, b, 2}^{MU} | . . . | Q_{p, b, N}^{MU} | Q_{p, b+1, 1}MU | Q_{p, b+1, 2}^{MU} | . . . | Q_{p, b+1, N}^{MU} |
| 1^{st} layer | UE1 | UE3 | . . . | UE 1 | UE1 | UE3 | . . . | UE 1 |
| 2^{nd} layer | UE2 | UE4 | . . . | UE7 | UE2 | UE4 | . . . | UE7 |
| 3^{rd} layer | UE4 | UE2 | . . . | UE9 | UE4 | UE2 | . . . | UE9 |
| 4^{th} layer | UE8 | UE8 | . . . | UE8 | UE8 | UE8 | . . . | UE8 |

where Q_{p,b,n}^{MU} represents the n^{th} TTI of the bundle b of the period p, and the 4^{th} layer indicates that the maximum number of UEs in the MU-UE list is restricted as 4 in this example. Other details may refer to the above description of Table 8 and will not be repeated here.

The situation where the DU uses the MU list provided by the RIC to assist scheduling is shown in Table 10.

TABLE 10

| | | NACK/ACK | MU-UE list Q_{p, b, t}^{MU} | MU-UE list input to |
|---|---|---|---|---|
| Situation | Time | feedback | provided by the RIC | DU MU layer decision |
| a) | t₁ of bunde b | UE1 and UE2 have | UE1, UE2, UE4, | \hat{Q}_{p, b, t}_{₁}^{MU} |
| | | NACK of historical | UE8 | (UE1, UE2, UE4, |
| | | uplink slots | | UE8) |
| b) | t_{N} of bunde b | No NACK feedback | UE1, UE7, UE9, | \hat{Q}_{p, b, t}_{_{N}}^{MU} |
| | | | UE8 | |
| | | | | (UE1, UE7, UE9, |
| | | | | UE8) |
| c) | t₁ of bunde b + 1 | UE6 and UE1 have | UE1, UE2, UE4, | \hat{R}_{p, b+1, t}_{₁}^{DU} |
| | | NACK of historical | UE8 | (UE6, UE1) |
| | | uplink slot | | |

For the situation a), at t₁ of bundle b, UE1 and UE2 have NACK of historical uplink slots and should perform retransmission. Since UE1 and UE2 are in the MU-UE list provided by the RIC, the DU may use the MU-UE list to perform MU layer decision.

For the situation b), at ty of bundle b, no NACK feedback is given. The DU may directly use the MU-UE list provided by the RIC to perform MU layer decision.

For the situation c), at t₁ of bundle b+1, UE6 and UE1 have NACK of historical uplink slots and should perform retransmission. Since UE6 is not in the MU-UE list provided by the RIC, the DU generates an MU-UE list of t₁ of bundle b+1 according to UE6 and UE1 and then uses the generated MU-UE list to perform MU layer decision.

It should be understood that the specific scheduling situations shown in Table 10 are merely illustrative, the specific NACK/ACK feedback situation, the MU-UE list provided by the RIC and the MU-UE list input to DU MU layer decision are subject to the actual implementation, and the scheduling examples in Table 10 should not be interpreted as any limitations to the present disclosure.

It is to be noted that the MU layer decision and resource allocation process may adopt the existing scheme, and it is not limited. Since the first network node fully considers the multi-user interference when generating the MU pairing recommendation result, the second network node performs MU layer decision based on the MU pairing recommendation result provided by the first network node, so that there is no risk of performance loss.

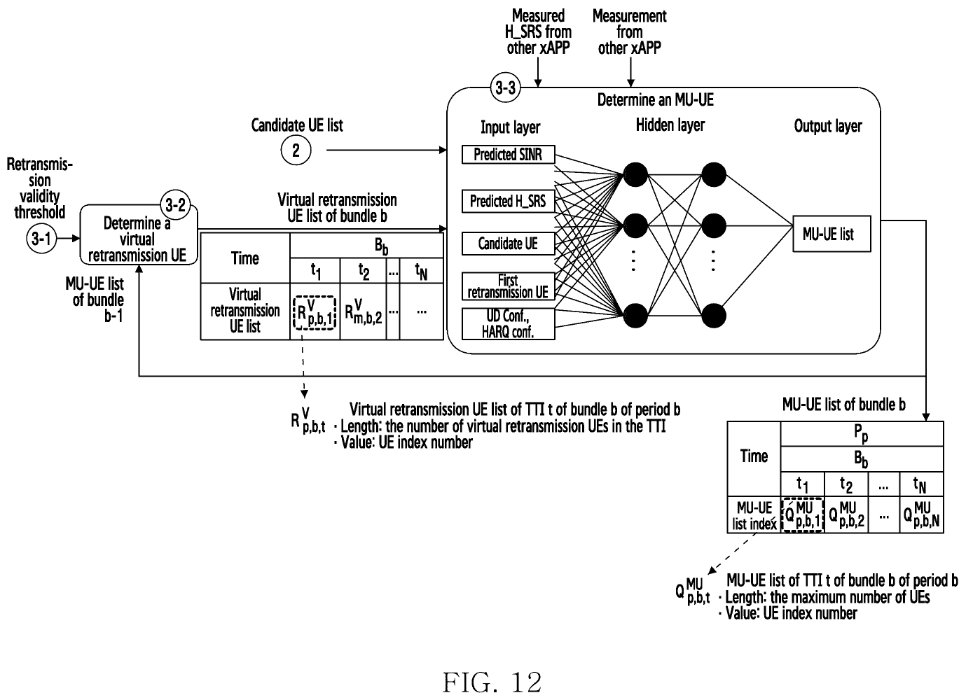

In an embodiment, the RTM-Net is used to determine the MU pairing recommendation result (e.g., the MU-UE list) of each first time unit (e.g., TTI) of each bundle and maximize/increase the throughput (e.g., sum MU-MPR), and the MU pairing recommendation result may include retransmission UEs. As shown in FIG. 12, the processing process of the RTM-Net includes the following.

The retransmission validity threshold and the MU-UE list of bundle b−1 generated in module 3-1 (the “module” in FIG. 12 corresponds to the “step 8-” in FIG. 8, and the same content hereinafter will not be repeated) are used to generate a virtual retransmission UE list in module 3-2. In the virtual retransmission U list of bundle b, R_{p,b,t}^{V} represents the virtual retransmission UE list of TTI t of the bundle b of the period p, the length is the number of virtual retransmission UEs in the TTI, and the value is the UE index number.

The candidate UE list generated in module 2 and the virtual retransmission UE list of bundle b generated in module 3-2 are used to generate an MU-UE list in module 3-3, and the input of module 303 also includes the predicted H_SRS from other xAPP that is used to calculate multi-user interference and the predicted SINR from other xAPP that is used to calculate sum MU MPR. Module 3-3 generates the MU-UE list of bundle b using a deep learning neural network in order to maximize/increase the throughput. In the MU-UE list of bundle b, Q_{p,b,t}^{MU} represents the MU-UE list of TTI t of the bundle b of the period p, the length is the maximum number of UEs, and the value is the UE index number.

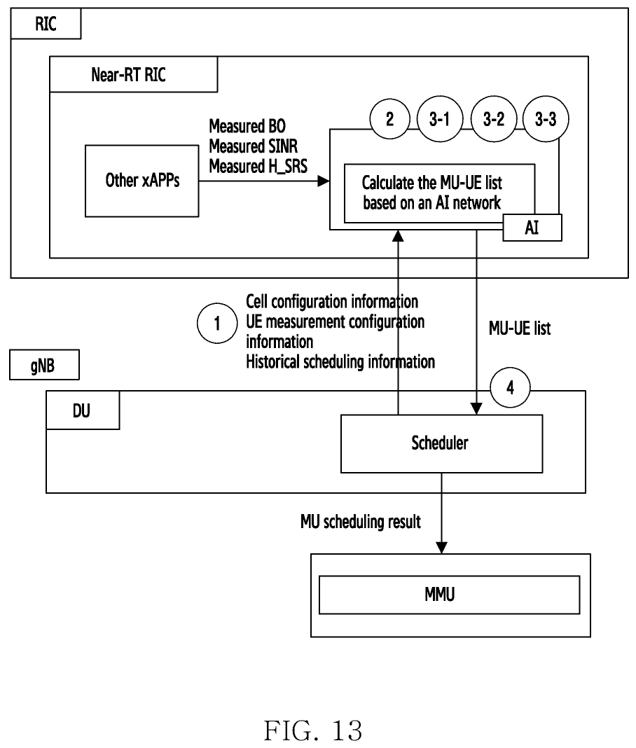

Based on at least one of the above, FIG. 13 shows an example of the deployment of an embodiment in the RIC and gNB, mainly including the following.

In step S13-1 (“13-” is omitted in FIG. 13, the same as in subsequent steps, which will not be repeated), the Near-RT RIC collects data to generate an MU-UE list, including but not limited to, receiving the UE measurement configuration information (UE meas. Conf.), cell configuration information (cell conf. Inf.) and historical scheduling information (historical sch. Inf.) from the gNB.

In step S13-2, the Near-RT RIC generates a candidate UE list for each TTI in one period, excluding UEs that cannot be scheduled due to the absence of service and UEs that are in corresponding TTIs of the measurement gap.

In step S13-3-1, the Near-RT RIC determines a validity strategy in one period according to the historical data. The validity strategy (e.g., the retransmission validity threshold Th_valid) is set to ensure that retransmission UEs are included in the MU-UE list.

In step S13-3-2, the Near-RT RIC determines the virtual retransmission UE list of each TTI of the current bundle according to the MU-UE list in the previous bundle, the predicted BO from other xAPPs and the retransmission validity threshold Th_vaild.

In step S13-3-3, the Near-RT RIC determines, for each bundle, the MU-UE list with the maximum throughput of each TTI of each bundle using the RTM-Net according to the virtual retransmission UE list, the candidate UE list, the predicted SINR from other xAPPs and the predicted H_SRS from other xAPPs. The MU-UE list of one period is generated according to the MU-UE list of each TTI of each bundle.

In step S13-4, the DU of the gNB uses the MU-UE list provided by the RIC, and the scheduler makes an MU layer decision on the TTI and performs resource allocation when the TTI satisfies the condition. The MU scheduling result is output to the MMU. The condition includes the following: 1) there is no actual retransmission UE; or, 2) all actual retransmission UEs are included in the MU-UE list provided by the RIC (if there are actual retransmission UEs).

The present disclosure can be applied to a massive antenna array scenario to perform MU pairing of UEs.

In an embodiment, the first network node determines retransmission UEs by predicting the retransmission probabilities of UEs and a validity strategy, thereby ensuring that the retransmission UEs are included in the MU pairing recommendation result as much as possible during the actual scheduling of the second network node, and ensuring the validity of the MU pairing recommendation result. Based on the predicted retransmission UEs and the channel state information (SINR, H_SRS, etc.) predicted for each UE, the MU pairing recommendation result is determined according to the maximum throughput criterion using a deep learning neural network, so that the cell throughput is improved. In short, by the scheme of the present disclosure, the complexity of MU scheduling of the second network node is reduced, and good performance can be maintained (ensuring the validity of retransmission UEs that can be included in the MU pairing recommendation result, and maximizing/increasing the cell throughput).

Experimentation has confirmed that the schedule of the present disclosure provides a more reasonable MU-UE list (MU pairing recommendation result) to the DU scheduler through the RIC, which has a gain of about 22% in comparison to the simplified mMIMO scheduler scheme. The scheme of the present disclosure can accurately predict retransmission UEs after certain iterations, and can finally achieve the expected 100% validity.

It can be seen that the scheme of the present disclosure can maintain the system performance by executing some functions of the mMIMO scheduler in the RIC. In addition, the scheme of the present disclosure addresses the retransmission delay problem by predicting the retransmission UE list in the RIC, and ensures that retransmission UEs are scheduled in time by enhancing the operation of the DU.

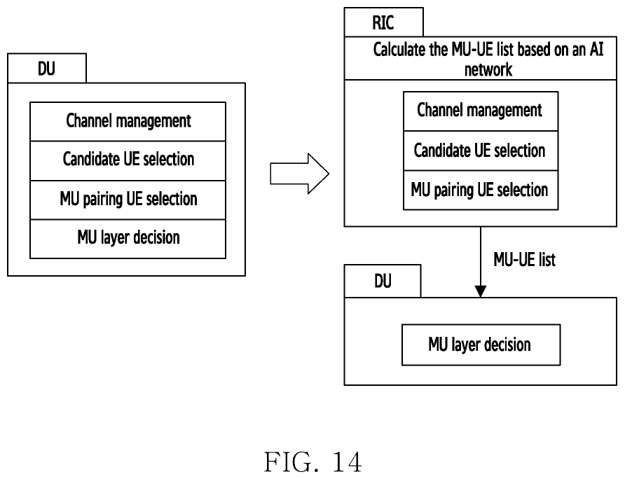

As shown in FIG. 14, the RIC (first network node)-based intelligent mMIMO scheme provided in an embodiment is equivalent to moving some of the basic mMIMO scheduling programs in the existing DU (second network node) to the RIC side to form a scheduling scheme combining the RIC with the DU mMIMO scheduler. The modules with high computation are decoupled through the RIC, so that the complexity of the DU is reduced. That is, by executing some functions of the mMIMO scheduler in the RIC, the complexity of the DU is greatly reduced, and the performance is maintained.

An embodiment provides a first network node (e.g., RIC), including: a transceiver, which is configured to transmit and receive signals; and, a processor, which is coupled to the transceiver and configured to implement the steps in the above method embodiments executed by a first network node.

An embodiment provides a second network node (e.g., DU), including: a transceiver, which is configured to transmit and receive signals; and, a processor, which is coupled to the transceiver and configured to implement the steps in the above method embodiments executed by a second network node.

The detailed functional description of the first network node and the second network node and the achieved beneficial effects can refer to the description of the above methods and will not be repeated here.

An embodiment further provides an electronic device, including a processor, and may optionally include a transceiver and/or memory coupled to the processor. The processor is configured to execute the steps of the method provided in any one of the optional embodiments of the present disclosure.

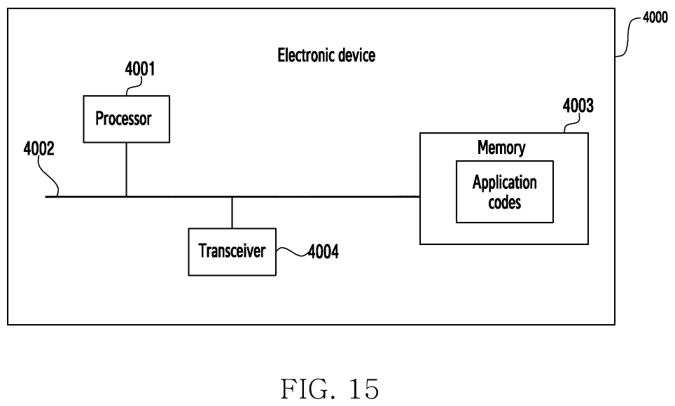

FIG. 15 is a block diagram illustrating an example configuration of an electronic device according to various embodiments. As shown in FIG. 15, the electronic device 4000 in FIG. 15 includes a processor (e.g., including processing circuitry) 4001 and a memory 4003. The processor 4001 is connected to the memory 4003, for example, via a bus 4002. Optionally, the electronic device 4000 may further include a transceiver 4004. The transceiver 4004 may be configured for data interaction between the electronic device and other electronic devices, for example, transmitting data and/or receiving data, etc. It is to be noted that, in practical applications, the number of the transceiver 4004 is not limited to 1, and the structure of the electronic device 4000 does not constitute any limitations to the embodiments of the present disclosure. Optionally, the electronic device may be a first network node, a second network node or a third network node.

The processor 4001 may include various processing circuitry, including, for example, a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor may implement or execute various example logic blocks, modules and circuits described in the disclosure. The processor 4001 may also be a combination for realizing computing functions, for example, a combination of one or more microprocessors, a combination of DSPs and microprocessors, etc. For example, the processor 4001 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a passageway for transferring information between the above components. The bus 4002 may be a peripheral component interconnect (PCI) bus, an extended industry standard architecture (EISA) bus, etc. The bus 4002 may be classified into address bus, data bus, control bus, etc. For ease of representation, the bus is represented by only one bold line in FIG. 15, but it does not mean that there is only one bus or one type of buses.

The memory 4003 may be, but not limited to, read only memories (ROMs) or other types of static storage devices capable of storing static information and instructions, random access memories (RAMs) or other types of dynamic storage devices capable of storing information and instructions, or electrically erasable programmable read only memories (EEPROMs), compact disc read only memories (CD-ROMs) or other optical disc storages, optical disc storages (including compact discs, laser discs, optical discs, digital versatile optical discs, Blue-ray discs, etc.), magnetic disc storage mediums or other magnetic storage devices, or any other medium that can be used to carry or store computer programs and can be accessed by a computer.

The memory 4003 is configured to store computer programs for executing the embodiments of the present disclosure, and is controlled and executed by the processor 4001. The processor 4001 is configured to execute the computer programs stored in the memory 4003 to implement the steps in the above method embodiments.

An embodiment provides a non-transitory computer-readable storage medium having computer programs stored thereon that, when executed by a processor, can implement the steps and corresponding contents in the above method embodiments.

An embodiment further provides a computer program product, including computer programs that, when executed by a processor, can implement the steps and corresponding contents in the above method embodiments.

For example, a method performed by a first network node in a communication system, may comprise identifying a first retransmission user equipment (UE), identifying information on a multi-user (MU) pairing recommendation result using a first artificial intelligence (AI) network based on the first retransmission UE, and transmitting the information on the MU pairing recommendation result to a second network node.

For example, the identifying a first retransmission UE may comprise determining a retransmission probability of at least one UE, and identifying a first retransmission UE based on the retransmission probability of the at least one UE.

For example, the determining the retransmission probability of at least one UE may comprise determining the retransmission probability of the at least one UE according to historical MU pairing recommendation results and a target block error rate.

For example, the determining the retransmission probability of the at least one UE according to historical MU pairing recommendation results and a target block error rate may comprise determining the number of times of using the at least one UE as initial transmission in the historical MU pairing recommendation results, determining the retransmission probability of initial transmission based on the target block error rate, and determining the retransmission probability of the at least one UE based on the number of times of the initial transmission and the retransmission probability of the initial transmission.

For example, the determining a first retransmission UE based on the retransmission probability of the at least one UE may comprise determining a retransmission validity threshold corresponding to the at least one UE, and determining a first retransmission UE based on the retransmission probability of the at least one UE and the retransmission validity threshold corresponding to the at least one UE.

For example, the determining a retransmission validity threshold corresponding to the at least one UE may comprise determining the retransmission validity threshold corresponding to the at least one UE according to historical scheduling information.

For example, the determining a retransmission validity threshold corresponding to the at least one UE according to historical scheduling information may comprise determining a historical MU pairing recommendation result validity metric according to the historical scheduling information, the MU pairing recommendation result validity metric being used to measure a validity of retransmission UEs in the historical MU pairing recommendation results, and determining, according to the historical MU pairing recommendation result validity metric and using a second AI network, a retransmission validity threshold corresponding to at least one UE in each first time unit set in a current period.

For example, the each first time unit set comprises at least one first time unit in which hybrid automatic repeat request (HARQ) feedback may be performed on a same continuous uplink second time unit.

For example, the historical scheduling information comprises at least one of the following: an MU-scheduled first time unit, a first time unit in which the second network node determines the MU pairing recommendation result, a first time unit in which the second network node uses the MU pairing recommendation result provided by the first network node, an actual usage condition of the MU pairing recommendation result provided by the first network node by the second network node in each first time unit set of the historical period, and the number of first time units MU-scheduled by the second network node in each first time unit set of the historical period.

For example, the identifying a first retransmission UE based on the retransmission probability of the at least one UE and the retransmission validity threshold corresponding to the at least one UE may comprise identifying a first retransmission UE based on a comparison result of the retransmission probability of the at least one UE and the retransmission validity threshold corresponding to the at least one UE.

For example, the identifying a first retransmission UE based on a comparison result of the retransmission probability of the at least one UE and the retransmission validity threshold corresponding to the at least one UE may comprise sorting the at least one UE in an order from smallest to largest retransmission probabilities, performing on the sorted at least one UE until a target UE is determined: determining a cumulative retransmission probability of a UE and UEs before this UE, determining the corresponding retransmission validity probability based on the cumulative retransmission probability, and determining this UE as a target UE based on the retransmission validity probability being less than the retransmission validity threshold, and identifying the target UE and UEs after the target UE as first retransmission UEs.

For example, the identifying the information on the MU pairing recommendation result using the first AI network based on the first retransmission UE may comprise determining at least one candidate UE according to the amount of data to be transmitted of UEs and measurement configuration information, and identifying information on the MU pairing recommendation result using the first AI network based on the first retransmission UE and the at least one candidate UE.

For example, the determining at least one candidate UE according to the amount of data to be transmitted of UEs and measurement configuration information may comprise determining at least one candidate UE according to the amount of data to be transmitted of UEs, the measurement configuration information and a UE scheduling parameter. The UE scheduling parameter may be determined according to the number of first time units in which UEs satisfy a specified condition in a specified period of time including a plurality of first time units.

For example, the determining at least one candidate UE according to the amount of data to be transmitted of UEs and measurement configuration information may comprise determining initial candidate UEs, and deleting, from the initial candidate UEs, candidate UEs whose amount of data to be transmitted is less than a first threshold, and deleting, from the initial candidate UEs, candidate UEs in measurement gaps according to the measurement configuration information, to obtain at least one candidate UE.

For example, the determining at least one candidate UE according to the amount of data to be transmitted of UEs, the measurement configuration information and a UE scheduling parameter may comprise determining initial candidate UEs, and deleting, from the initial candidate UEs, candidate UEs whose amount of data to be transmitted is less than a first threshold, deleting, from the initial candidate UEs, candidate UEs in measurement gaps according to the measurement configuration information, and sorting the initial candidate UEs according to the UE scheduling parameter and/or deleting, from the initial candidate UEs, candidate UEs whose UE scheduling parameter is greater than a fairness threshold, to obtain at least one candidate UE.

For example, a method performed by a second network node in a communication system, may comprise receiving information on a multi-user (MU) pairing recommendation result transmitted by a first network node, determining whether a current scheduling time unit uses the MU pairing recommendation result, and based on the current scheduling time unit using the MU pairing recommendation result, performing MU scheduling based on the MU pairing recommendation result.

For example, a first network node, may comprise a transceiver configured to transmit and/or receive signals, memory comprising at least one storage medium, storing instructions, and at least one processor comprising processing circuitry, wherein the instructions, when executed by the at least one processor individually or collectively, cause the first network node to identify a first retransmission user equipment (UE), identify information on a multi-user (MU) pairing recommendation result using a first artificial intelligence (AI) network based on the first retransmission UE, and transmit the information on the MU pairing recommendation result to a second network node.

For example, the instructions, when executed by the at least one processor individually or collectively, cause the first network node to: determine a retransmission probability of at least one UE, and identify a first retransmission UE based on the retransmission probability of the at least one UE.

For example, the instructions, when executed by the at least one processor individually or collectively, cause the first network node to determine the retransmission probability of the at least one UE according to historical MU pairing recommendation results and a target block error rate.

For example, a second network node, may comprise a transceiver configured to transmit and/or receive signals, and memory comprising at least one storage medium, storing instructions, and at least one processor comprising processing circuitry. The instructions, when executed by the at least one processor individually or collectively, cause the second network node to receive information on a multi-user (MU) pairing recommendation result transmitted by a first network node, determine whether a current scheduling time unit uses the MU pairing recommendation result, and based on the current scheduling time unit using the MU pairing recommendation result, perform MU scheduling based on the MU pairing recommendation result.

For example, a non-transitory computer readable storage medium storing one or more programs, wherein the one or more programs comprise instructions, when executed by a processor of a first network node, cause the first network node to identify a first retransmission user equipment (UE), identify information on a multi-user (MU) pairing recommendation result using a first artificial intelligence (AI) network based on the first retransmission UE, and transmit the information on the MU pairing recommendation result to a second network node.

For example, a non-transitory computer readable storage medium storing one or more programs, wherein the one or more programs comprise instructions, when executed by a processor of a first network node, cause the second network node to receive information on a multi-user (MU) pairing recommendation result transmitted by a first network node, determine whether a current scheduling time unit uses the MU pairing recommendation result, and based on the current scheduling time unit using the MU pairing recommendation result, perform MU scheduling based on the MU pairing recommendation result.

The terms “first”, “second”, “third”, “fourth”, “1”, “2”, etc. (if any) in the specification and claims and the accompanying drawings are used for distinguishing similar objects, rather than describing a particular order or precedence.

It should be understood that data, as used in such a way, may be used interchangeably if appropriate, so that various embodiments described herein may be implemented in an order other than those illustrated or described here.

It should be understood that although the steps in the flowchart of the various embodiments of the present disclosure are sequentially displayed by following the arrows, these steps are not necessarily performed in the order indicated by the arrows. Unless explicitly stated herein, in various implementation scenarios of various embodiments of the present disclosure, the steps in the flowcharts may be executed in other sequences as required. In addition, based on the actual implementation scenario, some or all of the steps in the flowcharts may include multiple sub-steps or multiple stages. Some or all of the sub-steps or stages may be executed at the same moment of time, and each of the sub-steps or stages may be executed at different moments of time. In scenarios with different execution times, the execution order of these sub-steps or stages may be flexibly configured according to requirements, which is not limited in the embodiments of the present disclosure.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

No claim element is to be construed under the provisions of 35 U.S.C. § 112, sixth paragraph, unless the element is expressly recited using the phrase “means for” or “means.”

What is claimed is:

1. A method performed by a first network node in a communication system, comprising:
identifying a first retransmission user equipment (UE);
identifying information on a multi-user (MU) pairing recommendation result using a first artificial intelligence (AI) network based on the first retransmission UE; and
transmitting the information on the MU pairing recommendation result to a second network node.

2. The method according to claim 1, wherein the identifying a first retransmission UE comprises:
determining a retransmission probability of at least one UE; and
identifying a first retransmission UE based on the retransmission probability of the at least one UE.

3. The method according to claim 2, wherein the determining the retransmission probability of at least one UE comprises:
determining the retransmission probability of the at least one UE according to historical MU pairing recommendation results and a target block error rate.

4. The method according to claim 3, wherein the determining the retransmission probability of the at least one UE according to historical MU pairing recommendation results and a target block error rate comprises:
determining the number of times of using the at least one UE as initial transmission in the historical MU pairing recommendation results;
determining the retransmission probability of initial transmission based on the target block error rate; and
determining the retransmission probability of the at least one UE based on the number of times of the initial transmission and the retransmission probability of the initial transmission.

5. The method according to claim 2, wherein the determining a first retransmission UE based on the retransmission probability of the at least one UE comprises:
determining a retransmission validity threshold corresponding to the at least one UE; and
determining a first retransmission UE based on the retransmission probability of the at least one UE and the retransmission validity threshold corresponding to the at least one UE.

6. The method according to claim 5, wherein the determining a retransmission validity threshold corresponding to the at least one UE comprises:
determining the retransmission validity threshold corresponding to the at least one UE according to historical scheduling information.

7. The method according to claim 6, wherein the determining a retransmission validity threshold corresponding to the at least one UE according to historical scheduling information comprises:
determining a historical MU pairing recommendation result validity metric according to the historical scheduling information, the MU pairing recommendation result validity metric being used to measure a validity of retransmission UEs in the historical MU pairing recommendation results; and
determining, according to the historical MU pairing recommendation result validity metric and using a second AI network, a retransmission validity threshold corresponding to at least one UE in each first time unit set in a current period.

8. The method according to claim 7, wherein the each first time unit set comprises at least one first time unit in which hybrid automatic repeat request (HARQ) feedback is performed on a same continuous uplink second time unit.

9. The method according to claim 6, wherein the historical scheduling information comprises at least one of the following:
an MU-scheduled first time unit;
a first time unit in which the second network node determines the MU pairing recommendation result;
a first time unit in which the second network node uses the MU pairing recommendation result provided by the first network node;
an actual usage condition of the MU pairing recommendation result provided by the first network node by the second network node in each first time unit set of the historical period; and
the number of first time units MU-scheduled by the second network node in each first time unit set of the historical period.

10. The method according to claim 6, wherein the identifying a first retransmission UE based on the retransmission probability of the at least one UE and the retransmission validity threshold corresponding to the at least one UE comprises:
identifying a first retransmission UE based on a comparison result of the retransmission probability of the at least one UE and the retransmission validity threshold corresponding to the at least one UE.

11. The method according to claim 10, wherein the identifying a first retransmission UE based on a comparison result of the retransmission probability of the at least one UE and the retransmission validity threshold corresponding to the at least one UE comprises:
sorting the at least one UE in an order from smallest to largest retransmission probabilities;
performing on the sorted at least one UE until a target UE is determined: determining a cumulative retransmission probability of a UE and UEs before this UE, determining the corresponding retransmission validity probability based on the cumulative retransmission probability, and determining this UE as a target UE based on the retransmission validity probability being less than the retransmission validity threshold; and
identifying the target UE and UEs after the target UE as first retransmission UEs.

12. The method according to claim 1, wherein the identifying the information on the MU pairing recommendation result using the first AI network based on the first retransmission UE comprises:
determining at least one candidate UE according to the amount of data to be transmitted of UEs and measurement configuration information; and
identifying information on the MU pairing recommendation result using the first AI network based on the first retransmission UE and the at least one candidate UE.

13. The method according to claim 12, wherein the determining at least one candidate UE according to the amount of data to be transmitted of UEs and measurement configuration information comprises:
determining at least one candidate UE according to the amount of data to be transmitted of UEs, the measurement configuration information and a UE scheduling parameter;
wherein the UE scheduling parameter is determined according to the number of first time units in which UEs satisfy a specified condition in a specified period of time including a plurality of first time units.

14. The method according to claim 12, wherein the determining at least one candidate UE according to the amount of data to be transmitted of UEs and measurement configuration information comprises:
determining initial candidate UEs; and
deleting, from the initial candidate UEs, candidate UEs whose amount of data to be transmitted is less than a first threshold, and deleting, from the initial candidate UEs, candidate UEs in measurement gaps according to the measurement configuration information, to obtain at least one candidate UE.

15. The method according to claim 13, wherein the determining at least one candidate UE according to the amount of data to be transmitted of UEs, the measurement configuration information and a UE scheduling parameter comprises:
determining initial candidate UEs; and
deleting, from the initial candidate UEs, candidate UEs whose amount of data to be transmitted is less than a first threshold, deleting, from the initial candidate UEs, candidate UEs in measurement gaps according to the measurement configuration information, and sorting the initial candidate UEs according to the UE scheduling parameter and/or deleting, from the initial candidate UEs, candidate UEs whose UE scheduling parameter is greater than a fairness threshold, to obtain at least one candidate UE.

16. A method performed by a second network node in a communication system, comprising:
receiving information on a multi-user (MU) pairing recommendation result transmitted by a first network node;
determining whether a current scheduling time unit uses the MU pairing recommendation result; and
based on the current scheduling time unit using the MU pairing recommendation result, performing MU scheduling based on the MU pairing recommendation result.

17. A first network node, comprising:
a transceiver configured to transmit and/or receive signals;
memory comprising at least one storage medium, storing instructions; and
at least one processor comprising processing circuitry,
wherein the instructions, when executed by the at least one processor individually or collectively, cause the first network node to:
identify a first retransmission user equipment (UE);
identify information on a multi-user (MU) pairing recommendation result using a first artificial intelligence (AI) network based on the first retransmission UE; and
transmit the information on the MU pairing recommendation result to a second network node.

18. The first network node of claim 17, wherein the instructions, when executed by the at least one processor individually or collectively, cause the first network node to:
determine a retransmission probability of at least one UE; and
identify a first retransmission UE based on the retransmission probability of the at least one UE.

19. The first network node of claim 18, wherein the instructions, when executed by the at least one processor individually or collectively, cause the first network node to determine the retransmission probability of the at least one UE according to historical MU pairing recommendation results and a target block error rate.

20. A second network node, comprising:
a transceiver configured to transmit and/or receive signals; and
memory comprising at least one storage medium, storing instructions; and
at least one processor comprising processing circuitry,
wherein the instructions, when executed by the at least one processor individually or collectively, cause the second network node to:
receive information on a multi-user (MU) pairing recommendation result transmitted by a first network node;
determine whether a current scheduling time unit uses the MU pairing recommendation result; and
based on the current scheduling time unit using the MU pairing recommendation result, perform MU scheduling based on the MU pairing recommendation result.
